(19) United States
(12) Patent Application Publication
(10) Pub. No.: US 2025/0156436 A1
(43) Pub. Date: May 15, 2025

(54) METHOD OF GENERATING A LAKEHOUSE METADATA SERVICE LOG, A METHOD OF QUERYING A LAKEHOUSE METADATA SERVICE LOG, ELECTRONIC DEVICE AND STORAGE MEDIUM

(71) Applicant: Beijing Volcano Engine Technology Co., Ltd., Beijing (CN)

(72) Inventors: Mengjun LI, Beijing (CN); Jun GUO, Beijing (CN); Ke SUN, Beijing (CN); Qing XU, Beijing (CN)

(21) Appl. No.: 18/941,424

(22) Filed: Nov. 8, 2024

(30) Foreign Application Priority Data
Nov. 9, 2023 (CN) 202311490261.1

(51) Int. Cl. G06F 16/25

(52) U.S. Cl. CPC G06F 16/254

(57) ABSTRACT

A method of generating a lakehouse metadata service log, a method of querying a lakehouse metadata service log, an electrode device and a storage medium are provided. The method of generating a lakehouse metadata service log includes: after a metadata server receives a data processing request sent by a data engine, determining, by the metadata server, first request identification information based on the data processing request, such that the first request identification information is used for identifying the data processing request; and then executing, by the metadata server, the request processing logic corresponding to the data processing request, and generating a log corresponding to the request processing logic based on the first request identification information, such that the log carries the first request identification information.

### CROSS-REFERENCE TO RELATED APPLICATION

The present disclosure claims priority of the Chinese Patent Application No. 202311490261.1 filed on Nov. 9, 2023, the disclosure of which is incorporated herein by reference in its entirety as part of the present application.

### TECHNICAL FIELD

The present disclosure relates to a method of generating a lakehouse metadata service log, a method of querying a lakehouse metadata service log, an electronic device, and a storage medium.

### BACKGROUND

In some application scenarios (for example, a big data scenario), for a metadata service system (for example, a metadata service system such as Hive Metastore) and a data engine (for example, a data engine such as Presto or Spark) connected to the metadata service system, the metadata service system may provide some interfaces to the data engine, so that the data engine can access the metadata service system by calling the interfaces. For example, the data engine may send a request (for example, a metadata read request) to the metadata service system by means of an interface, so that the metadata service system can process the request.

However, a log in the data engine and a log in the metadata service system belong to different systems, resulting in log fragmentation and difficulty in correlating, thereby affecting execution of some log requirement tasks (for example, a task such as a troubleshooting task, a performance tuning task, or a log query task).

### SUMMARY

In order to solve the above technical problems, the present disclosure provides a method of generating a lakehouse metadata service log and a method of querying a lakehouse metadata service log and corresponding apparatus, an electronic device, and a storage medium.

In order to achieve the above objective, the technical solutions provided by the present disclosure are as follows.

The present disclosure provides a method of generating lakehouse metadata service log. The method is applied to a metadata server. The method includes:
receiving a data processing request sent by a data engine;
determining first request identification information based on request identification information carried in the data processing request, wherein the first request identification information is used for identifying the data processing request; and if the data engine provides a log identifier and generates a request tracking identifier for the data processing request, the request identification information includes the log identifier and the request tracking identifier; if the data engine does not provide a log identifier and generates a request tracking identifier for the data processing request, the request identification information includes the request tracking identifier; and
executing request processing logic corresponding to the data processing request, and generating a log corresponding to the request processing logic based on the first request identification information, wherein the log carries the first request identification information.

In a possible implementation, the log identifier is determined by a software development kit (SDK) in the data engine based on a target parameter of the data engine; and
if the data engine supports log identifier configuration, the target parameter is a log identifier pre-configured for the data engine;
if the data engine does not support log identifier configuration, the target parameter is a task identifier, the task identifier is used for identifying a data analysis task of request generation logic that triggers the data processing request, and the data analysis task is created by the data engine in response to a user operation.

In a possible implementation, the request tracking identifier is used for uniquely identifying the data processing request; and/or
the request tracking identifier is generated by an SDK in the data engine.

In a possible implementation, the request identification information is located in a preset field in the data processing request; and/or
the request identification information is written by an SDK in the data engine into the preset field in the data processing request.

In a possible implementation, the method further includes:
if the data processing request does not carry the request identification information, determining the first request identification information based on at least one piece of request parameter information of the data processing request, wherein the at least one piece of request parameter information includes at least one of engine description information of the data engine and interface description information corresponding to the data processing request.

In a possible implementation, the first request identification information includes at least one of the at least one piece of request parameter information and a request tracking identifier generated by the metadata server for the data processing request; and/or
the step of if the data processing request does not carry the request identification information, determining the first request identification information based on at least one piece of request parameter information of the data processing request includes:
if the data engine does not provide a log identifier and does not generate a request tracking identifier for the data processing request, determining the first request identification information based on at least one piece of request parameter information of the data processing request.

In a possible implementation, the engine description information includes at least one of an engine identifier of the data engine and a user identifier of the data engine; and/or
the interface description information includes at least one of an interface identifier corresponding to the data processing request and an interface parameter corresponding to the data processing request.

In a possible implementation, the metadata server is a metadata service system.

In a possible implementation, the metadata server includes a metadata service gateway and at least one metadata service system; and
the determining first request identification information based on request identification information carried in the data processing request includes:
determining, by the metadata service gateway, the first request identification information based on the request identification information carried in the data processing request; and
the executing request processing logic corresponding to the data processing request, and generating a log corresponding to the request processing logic based on the first request identification information includes:
generating, by the metadata service gateway, a data processing message carrying the first request identification information based on the data processing request, sending, by the metadata service gateway, the data processing message to a target system in the at least one metadata service system, and generating, by the metadata service gateway, a metadata service gateway log corresponding to the data processing message based on the first request identification information, wherein the metadata service gateway log carries the first request identification information; and
executing, by the target system, message processing logic corresponding to the data processing message, and generating, by the target system, a system log corresponding to the message processing logic based on the first request identification information carried in the data processing message, wherein the system log carries the first request identification information.

In a possible implementation, the method further includes:
after the message processing logic corresponding to the data processing message is executed, clearing, by the target system, the first request identification information recorded in the target system, and sending, by the target system, a first feedback message to the metadata service gateway;
after the metadata service gateway receives the first feedback message, clearing, by the metadata service gateway, the first request identification information recorded in the metadata service gateway, and sending, by the metadata service gateway, a second feedback message to the data engine; and
after the data engine receives the second feedback message, if a target identifier corresponding to the first request identification information is recorded in the data engine, clearing, by the data engine, the target identifier recorded in the data engine.

In a possible implementation, if the data engine supports log identifier configuration and the first request identification information recorded in the data engine includes a log identifier and a request tracking identifier, the target identifier is the request tracking identifier.

In a possible implementation, if the data processing request carries the first request identification information, the data engine is configured to generate an engine log for the data processing request, and the engine log carries the first request identification information.

The present disclosure provides a method of querying a lakehouse metadata service log. The method is applied to a metadata server. The method includes:
receiving a log query request sent by a log request device, wherein the log query request is used for requesting to query a log corresponding to a data processing request that is sent by a data engine to the metadata server;
determining, as second request identification information, request identification information corresponding to the data processing request and carried in the log query request, wherein the second request identification information is used for identifying the data processing request; and
determining a log query result corresponding to the log query request based on a log carrying the second request identification information and existing in a log record of the metadata server, wherein the log in the log record is generated by using the lakehouse metadata service log generation method provided in the present disclosure.

In a possible implementation, the method further includes:
if the log query request does not carry the request identification information corresponding to the data processing request but carries a log query time range and at least one piece of request parameter information of the data processing request, generating the second request identification information based on the at least one piece of request parameter information carried in the log query request; or determining the second request identification information from the log record of the metadata server based on the log query time range and the at least one piece of request parameter information carried in the log query request, wherein the at least one piece of request parameter information includes at least one of engine description information of the data engine and interface description information corresponding to the data processing request; and
determining the log query result corresponding to the log query request based on a log that exists in the log record of the metadata server, that meets the log query time range, and that carries the second request identification information.

In a possible implementation, the log request device is configured to integrate the log query result fed back by the metadata server and a log recorded in the data engine for the data processing request, to obtain an integrated log, and the integrated log is used for describing a process executed by using the data engine and the metadata server for the data processing request.

In a possible implementation, if the log query request carries the request identification information corresponding to the data processing request, the log recorded in the data engine for the data processing request is a log carrying the request identification information and existing in a log record of the data engine.

In a possible implementation, the log request device is the data engine.

The present disclosure provides an apparatus of generating a lakehouse metadata service log, including:
a first receiving unit, configured to receive a data processing request sent by a data engine;
a first determination unit, configured to determine first request identification information based on request identification information carried in the data processing request, wherein the first request identification information is used for identifying the data processing request; and if the data engine provides a log identifier and generates a request tracking identifier for the data processing request, the request identification information includes the log identifier and the request tracking identifier; or if the data engine does not provide a log identifier but generates a request tracking identifier for the data processing request, the request identification information includes the request tracking identifier; and
a request processing unit, configured to execute request processing logic corresponding to the data processing request, and generate a log corresponding to the request processing logic based on the first request identification information, wherein the log carries the first request identification information.

The present disclosure provides an apparatus of querying a lakehouse metadata service log, including:
a second receiving unit, configured to receive a log query request sent by a log request device, wherein the log query request is used for requesting to query a log corresponding to a data processing request that is sent by a data engine to a metadata server;
a second determination unit, configured to determine, as second request identification information, request identification information corresponding to the data processing request and carried in the log query request, wherein the second request identification information is used for identifying the data processing request; and
a third determination unit, configured to determine a log query result corresponding to the log query request based on a log carrying the second request identification information and existing in a log record of the metadata server, wherein the log in the log record is generated by using the method of generating a lakehouse metadata service log provided in the present disclosure.

The present disclosure provides an electronic device, wherein the device includes a processor and a memory;
the memory is configured to store an instruction or a computer program; and
the processor is configured to execute the instruction or the computer program in the memory, so that the electronic device executes the method of generating a lakehouse metadata service log or the method of querying a lakehouse metadata service log provided in the present disclosure.

The present disclosure provides a non-transitory computer-readable storage medium, wherein the non-transitory computer-readable storage medium stores an instruction or a computer program that, when running on a device, causes the device to execute the method of generating a lakehouse metadata service log or the method of querying the lakehouse metadata service log provided in the present disclosure.

The present disclosure provides a computer program product, which includes a computer program carried on a non-transitory computer-readable storage medium, wherein the computer program includes program code for executing the method of generating a lakehouse metadata service log or the method of querying the lakehouse metadata service log provided in the present disclosure.

### BRIEF DESCRIPTION OF DRAWINGS

In order to more clearly describe the technical solutions in the embodiments of the present disclosure, the accompanying drawings for describing the embodiments or the related art will be briefly described below. It is clear that the accompanying drawings in the following description show merely some embodiments of the present disclosure, and a person of ordinary skill in the art may still derive other drawings from these accompanying drawings without creative efforts.

FIG. 1 is a flowchart of a method of generating a lakehouse metadata service log according to an embodiment of the present disclosure;

FIG. 2 is a schematic diagram of a communication process according to an embodiment of the present disclosure;

FIG. 3 is a schematic diagram of another communication process according to an embodiment of the present disclosure;

FIG. 4 is a schematic diagram of still another communication process according to an embodiment of the present disclosure;

FIG. 5 is a schematic diagram of a communication protocol according to an embodiment of the present disclosure;

FIG. 6 is a flowchart of a method of querying a lakehouse metadata service log according to an embodiment of the present disclosure;

FIG. 7 is a schematic diagram of a structure of an apparatus of generating a lakehouse metadata service log according to an embodiment of the present disclosure;

FIG. 8 is a schematic diagram of a structure of an apparatus of querying a lakehouse metadata service log according to an embodiment of the present disclosure; and

FIG. 9 is a schematic diagram of a structure of an electronic device according to an embodiment of the present disclosure.

### DETAILED DESCRIPTION

In order that those skilled in the art better understand the solutions of the present disclosure, the technical solutions in the embodiments of the present disclosure will be described clearly and completely below with reference to the accompanying drawings in the embodiments of the present disclosure. It is clear that the described embodiments are merely some but not all of the embodiments of the present disclosure. All other embodiments obtained by a person of ordinary skill in the art based on the embodiments of the present disclosure without creative efforts shall fall within the protection scope of the present disclosure.

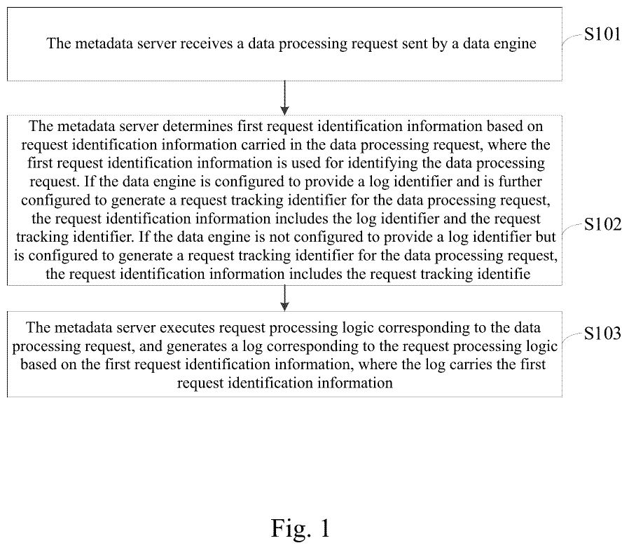

To better understand the technical solution provided in the present disclosure, the method of generating a lakehouse metadata service log provided in the present disclosure is first described below with reference to some accompanying drawings. As shown in FIG. 1, the method of generating a lakehouse metadata service log provided in the embodiment of the present disclosure includes the following S101 to S103. FIG. 1 is a flowchart of a method of generating a lakehouse metadata service log according to an embodiment of the present disclosure.

S101: A metadata server receives a data processing request sent by a data engine.

The metadata server is configured to process a request (for example, a metadata modification request, a metadata deletion request, or the like) sent by a specific data engine.

In addition, the implementation of the metadata server is not limited in the present disclosure. For ease of understanding, the following description is provided by using two cases.

Case 1: For some application scenarios (for example, a scenario with a low data processing pressure), these application scenarios may provide data services (for example, services such as metadata modification, metadata deletion, and metadata addition) to an upstream data engine by using only one metadata service system (for example, a metadata service system such as Hive Metastore).

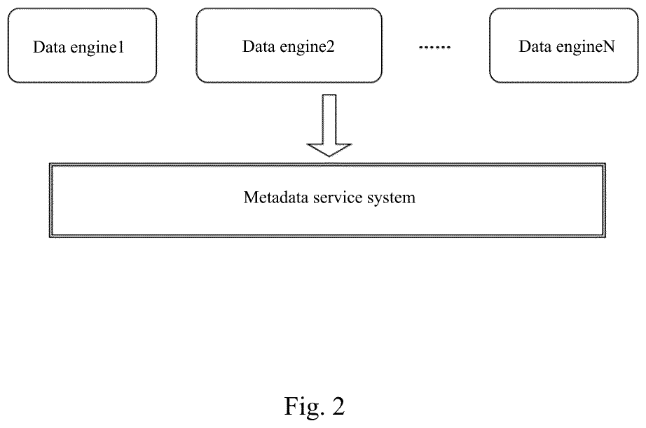

It can be learned from the foregoing Case 1 that, in a possible implementation, the foregoing metadata server may be a metadata service system, so that S101 to S103 implemented based on the metadata server are configured to describe performing related processing (for example, request generation processing, and executing request processing logic corresponding to the request) on a specific request (for example, a metadata modification request or a metadata deletion request) by using one metadata service system and at least one data engine (for example, Data Engine 1 to Data Engine N shown in FIG. 2, where N is a positive integer). The metadata service system refers to a system that can perform data management (for example, adding new data, deleting existing data, or modifying existing data) for some data sources, so that the metadata service system is configured to provide some data services (for example, services such as metadata modification, metadata deletion, and metadata addition).

It should be noted that the implementation of the foregoing metadata service system is not limited in the present disclosure. For example, in some application scenarios (for example, a data lakehouse scenario), the metadata service system may be implemented by using any metadata service system (for example, a metadata service system such as a Hive Metastore instance) that can manage metadata, so that the metadata service system can perform data management on metadata in a data lakehouse. In addition, the implementation of the foregoing data source is not limited in the present disclosure. For example, the data source may be implemented by using any data source (for example, a data lake, a data warehouse, or a data lakehouse integration). Based on this, it can be learned that in a possible implementation, the metadata service system may be configured to perform data management on at least metadata in some data sources.

It can be learned from the foregoing two paragraphs that in some application scenarios, the foregoing metadata server may be a metadata service system (for example, a Hive Metastore instance), so that S101 to S103 implemented based on the metadata service system are configured to describe performing related processing (for example, request generation processing, and executing request processing logic corresponding to the request) on a specific metadata processing request by using the metadata service system and at least one data engine (for example, some upstream services of the metadata service system).

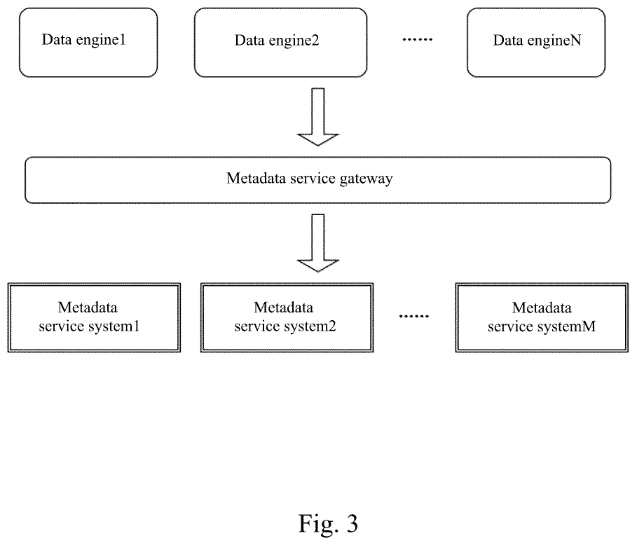

Case 2: For some application scenarios (for example, a scenario with a high data processing pressure), these application scenarios may provide data services (for example, services such as metadata modification, metadata deletion, and metadata addition) by using a plurality of metadata service systems (for example, Metadata Service System 1 to Metadata Service System M shown in FIG. 3, where M is a positive integer).

It can be learned from the foregoing Case 2 that, in a possible implementation, the foregoing metadata server may include a metadata service gateway (for example, the metadata service gateway shown in FIG. 3) and at least one metadata service system (for example, Metadata Service System 1 to Metadata Service System M shown in FIG. 3). The metadata service gateway is configured to receive a request sent by a specific data engine and route (for example, forward) the request to a specific metadata service system. It can be learned that the metadata service gateway is deployed between at least one data engine and at least one metadata service system, so that the metadata service gateway can be configured to assist in completing a communication process between the data engines and the metadata service systems. In addition, the implementation of the metadata service gateway is not limited in the present disclosure. For example, the metadata service gateway may be implemented by using any device (for example, a metadata service gateway implemented based on Hive Metastore) that can assist in completing a communication process between at least one data engine and at least one metadata service system.

It can be learned from the foregoing paragraph that in some application scenarios, the foregoing metadata server may include a metadata service gateway and at least one metadata service system, so that S101 to S103 implemented based on the metadata server are configured to describe performing related processing (for example, request generation processing, and executing request processing logic corresponding to the request) on a specific metadata processing request by using the at least one metadata service system, the metadata service gateway, and at least one data engine.

The data engine refers to an engine that can implement some metadata processing processes by means of the foregoing metadata server, so that the data engine is configured to represent an upstream service of the metadata server, and thus the data engine can use the metadata server in some manner (for example, an interface calling manner) to implement some data processing processes.

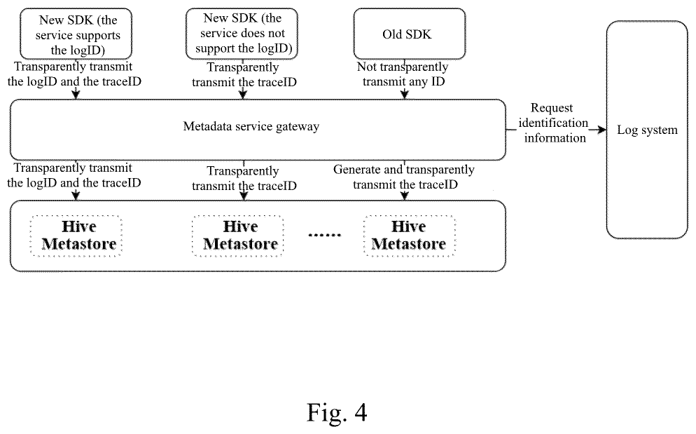

In addition, the implementation of the foregoing data engine is not limited in the present disclosure. For example, the data engine may be implemented by using any engine (for example, Data Engine 1, Data Engine 2, . . . , or Data Engine N shown in FIG. 3 or FIG. 4) that can be connected to the foregoing metadata server. For another example, in some application scenarios, the data engine may be implemented by using a data analysis engine, a data computing engine, or a data query engine. It can be seen that in a possible implementation, when the metadata service system in the metadata server is implemented by using a Hive Metastore instance, the data engine may be implemented by using a HiveServer2 engine, so that the data engine can call the metadata server by means of an interface, so that the metadata server can implement some data processing processes by processing a request provided by the data engine.

It should be noted that the implementation of the foregoing HiveServer2 engine is not limited in the present disclosure. For example, the HiveServer2 engine may include one or more of at least one structured query language (SQL) engine, at least one batch-stream processing engine, and at least one intelligent analysis platform engine.

It should further be noted that the implementation of the foregoing SQL engine is not limited in the present disclosure. For example, the SQL engine may be implemented by using any SQL engine (for example, an SQL engine such as Hive or Presto). In addition, the implementation of the foregoing batch-stream processing engine is not limited in the present disclosure. For example, the batch-stream processing engine may be implemented by using any batch-stream processing engine (for example, a batch-stream processing engine such as Spark or Flink). In addition, the implementation of the foregoing intelligent analysis platform engine is not limited in the present disclosure. For example, the intelligent analysis platform engine may be implemented by using any intelligent analysis platform engine, for example, a business intelligence (BI) analysis platform engine.

In addition, for the foregoing metadata server and the foregoing data engine, data communication may be performed between the data engine and the metadata server. In addition, a communication manner of the data communication is not limited in the present disclosure. For example, the data communication may be implemented by using any manner that can implement communication between the data engine and the metadata server. For another example, in some application scenarios, the data engine may access the metadata service system by calling an interface, so that the metadata service system can process some data processing requests (for example, a request such as modifying a table name) sent by the data engine by means of the interface. It should be noted that the implementation of the interface is not limited in the present disclosure. For example, in some application scenarios, the interface may be implemented by using a remote procedure call (RPC) interface. For another example, in some application scenarios, the interface may be implemented by using a Thrift interface.

In addition, the structure of the foregoing data engine is not limited in the present disclosure. For example, the data engine may be implemented by using any engine that can use the foregoing metadata service system to complete some data processing tasks. For another example, in some application scenarios, the data engine may access the metadata service system by using a software development kit (SDK) that is already deployed inside the data engine. The SDK refers to a toolkit that is deployed in the data engine in advance and that is used for implementing communication with the metadata service system. In addition, the working principle of the SDK is not limited in the present disclosure. For ease of understanding, the following description is provided by using some scenarios.

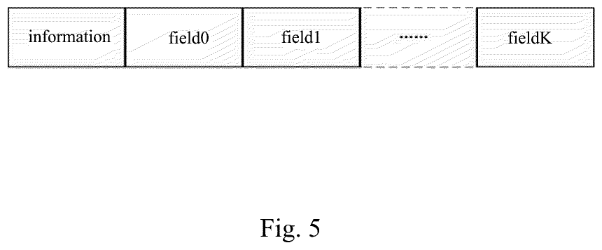

Scenario 1: If the foregoing data engine supports a log identifier (for example, a logID shown in FIG. 4), and an SDK deployed in the data engine has a request tracking identifier (for example, a traceID shown in FIG. 4) generation capability, the working principle of the SDK deployed in the data engine may be as follows: when the data engine wants to access the foregoing metadata server by using the SDK, the SDK may read the log identifier from the data engine, and place the log identifier into field 0 of a Thrift message (for example, the Thrift message shown in FIG. 5). In addition, the SDK automatically generates a globally unique request tracking identifier, so that the request tracking identifier is used for uniquely identifying a Thrift request (for example, the foregoing data processing request) that carries the Thrift message, and places the request tracking identifier into field 0 of the Thrift message, so that the Thrift request that is finally sent by the data engine to the metadata server by using the SDK carries the log identifier and the request tracking identifier, thereby implementing that the data engine transparently transmits the log identifier and the request tracking identifier to the metadata server by using the SDK.

It should be noted that the implementation of the step “The SDK may read the log identifier from the data engine” is not limited in the present disclosure. For example, if the data engine supports a mapped diagnostic context (MDC), it may be determined that the data engine supports log identifier configuration, and therefore the SDK deployed in the data engine may automatically read the log identifier from the MDC of the data engine. If the data engine does not support the MDC, it may be determined that the data engine does not support log identifier configuration, and therefore the SDK deployed in the data engine may obtain a log identifier based on a related configuration in the data engine. In addition, the implementation of the step “obtaining a log identifier based on a related configuration in the data engine” is not limited in the present disclosure. As an example, when a related configuration of a data engine Spark indicates that a data analysis task identifier applicationId may be used as a log identifier, the SDK deployed in the Spark may automatically obtain the applicationId from the Spark, and use the applicationId as a log identifier, so that the SDK can subsequently place the log identifier into some field (for example, field 0 shown in FIG. 5) in a Thrift request generated based on the data analysis task, and send the Thrift request to a metadata server.

Scenario 2: If the foregoing data engine does not support a log identifier but an SDK deployed in the data engine has a request tracking identifier generation capability, the working principle of the SDK deployed in the data engine may be as follows: when the data engine wants to access the foregoing metadata server by using the SDK, the SDK automatically generates a globally unique request tracking identifier for a data analysis task provided by the data engine, so that the request tracking identifier is used for uniquely identifying a Thrift request (for example, the foregoing data processing request) generated based on the data analysis task, and places the request tracking identifier into field 0 of a Thrift message carried in the Thrift request, so that the Thrift request that is finally sent by the data engine to the metadata server by using the SDK carries the request tracking identifier, thereby implementing that the data engine transparently transmits the request tracking identifier to the metadata server by using the SDK.

It should be noted that the correspondence between the data analysis task and the Thrift request is not limited in the present disclosure. If the data analysis task describes only one data processing requirement (for example, deleting a specific table partition), there is a one-to-one correspondence between the data analysis task and the Thrift request, so that the Thrift request conveys the data processing requirement to the metadata server. However, if the data analysis task describes a plurality of data processing requirements (for example, deleting a plurality of table partitions), a plurality of Thrift requests may be generated based on the data analysis task, so that each Thrift request may be used to convey one data processing requirement (for example, deleting one table partition) to the metadata server, so that the data analysis task corresponds to the plurality of Thrift requests, and therefore the foregoing data engine needs to access the metadata server a plurality of times by using an SDK to complete the data analysis task.

Scenario 3: If the foregoing data engine does not support a log identifier and an SDK deployed in the data engine does not have a request tracking identifier generation capability, the working principle of the SDK deployed in the data engine may be as follows: when the data engine wants to access the foregoing metadata server by using the SDK, the SDK only needs to generate a Thrift request based on a data analysis task provided by the data engine, so that the Thrift request can represent a data processing requirement described by the data analysis task, so that after the SDK sends the Thrift request to the metadata server, in order to better connect a log in the data engine and a log in the metadata server, the metadata server needs to obtain and record some parameters of the Thrift request, for example, parameters such as an interface name, a delivering parameter, an Internet protocol address (IP address) of a client, and a user name of the Thrift request, so that the metadata server can perform log generation processing based on the parameters, so that it can be learned later by means of the information that a log recorded in the data engine for the Thrift request and a log generated in the metadata server based on the parameters belong to a related log of the same Thrift request.

It can be learned from the foregoing data engine that in some application scenarios, for the data engine, after the data engine detects a specific user operation (for example, an operation of entering an SQL query statement “alter table test_db.test_tbl rename to test_db.test_tbl_new”), the data engine may create a data analysis task for the user operation, so that the data analysis task can represent a data processing requirement conveyed by the user operation, so that an SDK (for example, any SDK shown in FIG. 4) deployed in the data engine can generate a data processing request based on the data analysis task, and the SDK sends the data processing request to a metadata server (for example, a metadata service gateway in the metadata server), so that the metadata server implements the data processing requirement by processing the data processing request.

The data processing request refers to a request sent by the foregoing data engine to the foregoing metadata server and used for requesting to perform a specific processing (for example, a table name modification processing, deleting data in a specific column, adding a new column of data, or the like) on a specific data object (for example, a database, a table, a partition, metadata, or the like). In addition, the implementation of the data processing request is not limited in the present disclosure. For example, the data processing request may be implemented by using any request sent by the data engine to the metadata server and used for requesting a specific data processing. The data object refers to an object that can be processed by the metadata server. In addition, the implementation of the data object is not limited in the present disclosure. For example, the data object may be implemented by using a database, a table, a partition, metadata, or the like.

In fact, in some application scenarios (for example, a scenario in which each SDK deployed in a data engine is upgraded to a new SDK shown in FIG. 4), in order to better connect a log in the data engine and a log in the metadata server, the present disclosure provides a possible implementation of the foregoing data processing request. In this implementation, the data processing request carries request identification information (for example, a logID and a traceID shown in FIG. 4), so that the metadata server can subsequently obtain the request identification information from the data processing request. The request identification information is used for identifying the data processing request, so that the request identification information can represent a feature of the data processing request. In addition, the implementation of the request identification information is not limited in the present disclosure. For ease of understanding, the following description is provided by using two cases.

Case 1: In some application scenarios, if the foregoing data engine supports a log identifier and an SDK deployed in the data engine has a request tracking identifier generation capability, a request (for example, a Thrift request) generated by the SDK may carry a log identifier and a request tracking identifier, and therefore features of the request may be reflected by using the two identifiers.

It can be learned from the foregoing Case 1 that, in a possible implementation, if the foregoing data engine is configured to provide a log identifier (for example, the data engine supports the log identifier) and is further configured to generate a request tracking identifier for the foregoing data processing request, the request identification information carried in the data processing request may include a log identifier (for example, the logID shown in FIG. 4) and a request tracking identifier (for example, the traceID shown in FIG. 4), so that the request identification information can better represent the feature of the data processing request, so that the data processing request can not only convey a data processing requirement to the metadata server, but also notify the metadata server of identification information involved in the data engine for the data processing request, thereby facilitating connection of the log in the metadata server and the log in the data engine.

The log identifier refers to an identifier (for example, the logID shown in FIG. 4) that needs to be used when the foregoing data engine creates a log for the foregoing data processing request, so that the log identifier can be used for identifying an object (for example, a specific task or a specific thread) that triggers request generation logic of the data processing request in the data engine. The request generation logic refers to processing logic (for example, the logic involved in the generation process of the foregoing data processing request) that is executed by the data engine and that is used for generating the data processing request, so that the data engine generates the data processing request by executing the request generation logic.

In addition, the implementation of the foregoing log identifier is not limited in the present disclosure. For example, in some application scenarios, the log identifier may be implemented by using the logID shown in FIG. 4.

In addition, the obtaining manner of the foregoing log identifier is not limited in the present disclosure. For example, the obtaining manner may be implemented by using any method that can obtain a log identifier (for example, a logID).

In addition, in order to better improve an effect of obtaining the log identifier, the present disclosure further provides an obtaining manner of the log identifier. In this implementation, the log identifier is determined by an SDK in the foregoing data engine based on a target parameter of the data engine. The SDK refers to a toolkit that is already deployed in the data engine and that is used for implementing communication with the metadata server. The target parameter refers to a parameter that needs to be used when the SDK obtains the log identifier from the data engine. In addition, the implementation of the target parameter is not limited in the present disclosure. For example, if the data engine is configured to provide a log identifier and supports log identifier configuration (for example, the data engine supports an MDC or the like), the target parameter may be a log identifier pre-configured for the data engine, so that the SDK may directly use the target parameter as the log identifier (for example, the SDK may read the log identifier from the MDC of the data engine or the like). If the data engine is configured to provide a log identifier but does not support log identifier configuration (for example, the data engine does not support the MDC or the like), the target parameter may be a task identifier (for example, an applicationId), so that the SDK may directly use the target parameter as the log identifier (for example, the SDK needs to consider the applicationId as the log identifier or the like). The task identifier is used for identifying a data analysis task of request generation logic that triggers the data processing request, and the data analysis task is created by the data engine in response to a user operation. It should be noted that for related content of the data analysis task, refer to the foregoing description.

It can be learned from the foregoing content that in a possible implementation, for the foregoing data engine, the working principle of the data engine may be as follows: after detecting a user operation, the data engine creates a data analysis task for the user operation, so that the data analysis task can represent a data analysis requirement conveyed by the user operation; and then an SDK deployed in the data engine obtains a target parameter of the data engine (for example, reading a logID from the MDC or obtaining a task identifier of the data analysis task), and uses the target parameter as a log identifier, so that the SDK subsequently generates a data processing request based on the log identifier, so that the data processing request carries the log identifier.

In addition, the implementation of the content “the data processing request carries the log identifier” is not limited in the present disclosure. For example, in some application scenarios, in order to reduce a transformation cost as much as possible, an idle field in an existing communication protocol (for example, a Thrift protocol) between a data engine and a metadata server may be used to record the log identifier. Based on this, it can be learned that in a possible implementation, an SDK in the foregoing data engine may be configured to write a log identifier into a first field in the data processing request in a generation process of the data processing request, so that the log identifier can be transmitted (for example, transmitted transparently) by means of the first field. The first field refers to a field in the data processing request that is used for recording the log identifier. In addition, the implementation of the first field is not limited in the present disclosure. For example, the first field may be implemented by using a field in an idle state in the data processing request. It can be seen that when the data processing request is implemented by using a Thrift protocol format shown in FIG. 5, the first field may be implemented by using an idle field 0 (for example, Field0).

The request tracking identifier is used for uniquely identifying the foregoing data processing request, so that the request tracking identifier can be used for identifying an access process of the foregoing data engine to the metadata server. In addition, the implementation of the request tracking identifier is not limited in the present disclosure. For example, in some application scenarios, the request tracking identifier may be implemented by using the traceID shown in FIG. 4.

In addition, the obtaining manner of the foregoing request tracking identifier is not limited in the present disclosure. For example, in some application scenarios, the request tracking identifier may be generated by an SDK in the foregoing data engine. In addition, the generation process is not limited in the present disclosure. For example, the generation process may specifically be as follows: the SDK may automatically generate the request tracking identifier in the generation process of the foregoing data processing request, so that the request tracking identifier can uniquely identify the data processing request, so that the SDK subsequently generates the data processing request based on the request tracking identifier, so that the data processing request carries the request tracking identifier.

It should be noted that the implementation of the content “the data processing request carries the request tracking identifier” is not limited in the present disclosure. For example, in some application scenarios, in order to reduce a transformation cost as much as possible, an idle field in an existing communication protocol (for example, a Thrift protocol) between a data engine and a metadata server may be used to record the request tracking identifier. Based on this, it can be learned that in a possible implementation, an SDK in the foregoing data engine may be configured to write the request tracking identifier into a second field in the data processing request in a generation process of the data processing request, so that the request tracking identifier can be transmitted (for example, transmitted transparently) by means of the second field. The second field refers to a field in the data processing request that is used for recording the request tracking identifier. In addition, the implementation of the second field is not limited in the present disclosure. For example, the second field may be implemented by using a field in an idle state in the data processing request. It can be seen that when the data processing request is implemented by using a Thrift protocol format shown in FIG. 5, the second field may be implemented by using an idle field 0 (for example, Field0).

It should further be noted that the association between the foregoing first field and the foregoing second field is not limited in the present disclosure. For example, in some application scenarios, the two fields are different fields. For another example, in some application scenarios, in order to better improve an information amount recorded in each field, the first field and the second field may be a same field (for example, field 0 shown in FIG. 5), so that the foregoing log identifier and the foregoing request tracking identifier are transmitted by using a same field.

It can be learned from the foregoing Case 1, the related content of the foregoing log identifier, and the related content of the foregoing request tracking identifier that, for a data processing request sent by a data engine to a metadata server, in some application scenarios, the data processing request may carry request identification information, and the request identification information carried in the data processing request may include a log identifier and a request tracking identifier, so that the data engine can provide the log identifier and the request tracking identifier in the metadata server by sending the data processing request to the metadata server, so that the metadata server can subsequently perform log generation processing by means of the log identifier and the request tracking identifier, so that all logs related to the data processing request can be queried from the data engine and the metadata server by means of the log identifier and the request tracking identifier later, thereby facilitating connection of the log in the data engine and the log in the metadata server.

Case 2: In some application scenarios, if the foregoing data engine does not support a log identifier but an SDK deployed in the data engine has a request tracking identifier generation capability, a request (for example, a Thrift request) generated by the SDK may carry a request tracking identifier, and therefore a feature of the request may be reflected by using the identifier.

It can be learned from the foregoing Case 2 that, in a possible implementation, if the foregoing data engine is not configured to provide a log identifier but is configured to generate a request tracking identifier for the foregoing data processing request, the request identification information carried in the data processing request includes the request tracking identifier, so that the request identification information can better represent the feature of the data processing request.

It can be seen that for the foregoing data processing request, in some application scenarios, the request identification information carried in the data processing request may include a request tracking identifier, so that the foregoing data engine can provide the request tracking identifier in the metadata server by sending the data processing request to the metadata server, so that the metadata server can subsequently perform log generation processing with by means of the request tracking identifier, so that all logs related to the data processing request can be queried from the data engine and the metadata server by means of the request tracking identifier later, thereby facilitating connection of the log in the data engine and the log in the metadata server.

It can be learned from the foregoing related content of the data processing request that in a possible implementation, the data processing request may carry request identification information, so that the request identification information is used for identifying the data processing request. In addition, a carrying manner of the data processing request for the request identification information is not limited in the present disclosure. For example, in some application scenarios, the request identification information is located in a preset field (for example, the field 0 shown in FIG. 4) in the data processing request. The preset field refers to a field in the data processing request that is used for recording the request identification information. In addition, the implementation of writing the request identification information into the data processing request is not limited in the present disclosure. For example, in some application scenarios, the request identification information may be written into the preset field in the data processing request by an SDK in the foregoing data engine, so that the preset field in the data processing request records the request identification information, so that the metadata server can subsequently read the request identification information from the preset field.

In addition, for the foregoing data engine, the data engine may not only be configured to send a data processing request to a metadata server, but also be configured to generate an engine log for the data processing request, so that the engine log can represent an item (for example, a generation process of the data processing request) related to the data processing request that occurs in the data engine. The engine log refers to a log generated in the data engine and used for recording various items that occur in the data engine. In addition, the implementation of the engine log is not limited in the present disclosure. For ease of understanding, the following description is provided by using an example.

As an example, in some application scenarios (for example, an SDK deployed in the data engine is a new SDK shown in FIG. 4), in order to better connect a log in the data engine and a log in the metadata server, the present disclosure provides a possible implementation of the foregoing engine log. In this implementation, if the data engine can further provide request identification information (for example, a logID and a traceID shown in FIG. 4) to the metadata server when sending a data processing request to the metadata server, the data processing request carries the request identification information (for example, first request identification information described below), and the data engine may be configured to generate an engine log for the data processing request, so that the engine log carries the request identification information, so that the log can be queried based on the request identification information subsequently, thereby facilitating connection of the log in the data engine and the log in the metadata server.

It should be noted that the specific working principle of the data engine is not limited in the present disclosure. For example, the specific working principle may be as follows: for an SDK in the data engine, when the SDK generates and sends a data processing request based on the foregoing request identification information (for example, the first request identification information described below), the SDK may record the request identification information in a log created by the data engine for the data processing request, so that the log can be queried based on the request identification information subsequently, thereby facilitating connection of the log in the data engine and the log in the metadata server.

In addition, the implementation of S101 is not limited in the present disclosure. For example, in some application scenarios (for example, when a connection manner between a data engine and a metadata service system is similar to the connection manner shown in FIG. 2), if the foregoing metadata server includes a metadata service system, S101 may specifically be: the metadata service system receives a data processing request sent by a data engine, so that the metadata service system can subsequently perform corresponding processing on the data processing request.

For another example, in some application scenarios (for example, when a connection manner between a data engine and a metadata service system is similar to the connection manner shown in FIG. 3), if the foregoing metadata server includes a metadata service gateway and at least one metadata service system, S101 may specifically be: the metadata service gateway receives a data processing request sent by a data engine, so that the metadata service gateway can subsequently route the data processing request to a specific metadata service system in the at least one metadata service system based on a preset routing rule, so that the routed metadata service system can perform corresponding processing on the data processing request.

It can be learned from the foregoing related content of S101 that in some application scenarios (for example, a big data scenario), for a metadata server and a data engine that can perform data communication, the data engine may access the metadata server (for example, a metadata service gateway in the metadata server) by using an SDK that is already deployed in the data engine, so that the metadata server can subsequently perform corresponding processing on a data processing request (for example, the foregoing Thrift request) sent by the SDK.

S102: The metadata server determines first request identification information based on request identification information carried in the data processing request, where the first request identification information is used for identifying the data processing request. If the data engine is configured to provide a log identifier and is further configured to generate a request tracking identifier for the data processing request, the request identification information includes the log identifier and the request tracking identifier. If the data engine is not configured to provide a log identifier but is configured to generate a request tracking identifier for the data processing request, the request identification information includes the request tracking identifier.

The first request identification information refers to identification information determined by the metadata server based on the foregoing data processing request, so that the first request identification information is used for identifying the data processing request.

In addition, the determination process of the foregoing first request identification information is not limited in the present disclosure. For example, in some application scenarios, if the foregoing data processing request carries request identification information (for example, a logID and a traceID shown in FIG. 4), the determination process of the first request identification information may specifically be as follows: the metadata server determines the first request identification information based on the request identification information carried in the data processing request.

In addition, the implementation of the step “the metadata server determines the first request identification information based on the request identification information carried in the data processing request” is not limited in the present disclosure. For example, the implementation may specifically be as follows: the metadata server may directly determine the request identification information carried in the data processing request as the first request identification information. It can be seen that in some application scenarios, if the request identification information carried in the foregoing data processing request includes a log identifier and a request tracking identifier, the metadata server may determine the log identifier and the request tracking identifier carried in the data processing request as the first request identification information, so that the first request identification information includes the log identifier and the request tracking identifier, so that log generation processing can be subsequently performed based on the log identifier and the request tracking identifier, so that a finally generated log carries the log identifier and the request tracking identifier, and therefore log query processing can be subsequently performed based on the log identifier and the request tracking identifier. However, in some application scenarios, if the request identification information carried in the foregoing data processing request includes a request tracking identifier, the metadata server may determine the request tracking identifier carried in the data processing request as the first request identification information, so that the first request identification information includes the request tracking identifier, so that log generation processing can be subsequently performed based on the request tracking identifier, so that a finally generated log carries the request tracking identifier, and therefore log query processing can be subsequently performed based on the request tracking identifier.

In addition, in some application scenarios (for example, a scenario in which an SDK deployed in a data engine is not upgraded), the data engine may not be able to provide a log identifier and a request tracking identifier. Therefore, in order to better connect a log in the data engine and a log in the metadata server in this scenario, the present disclosure further provides a possible implementation of the determination process of the foregoing first request identification information. In this implementation, if the foregoing data processing request does not carry request identification information (for example, the data engine is not configured to provide a log identifier, and the data engine is not configured to generate a request tracking identifier for the foregoing data processing request), the determination process of the first request identification information may specifically be as follows: the metadata server generates the first request identification information based on at least one piece of request parameter information of the data processing request, so that the first request identification information can represent a feature of the data processing request. The at least one piece of request parameter information is used for describing the feature of the data processing request.

In addition, the implementation of the foregoing at least one piece of request parameter information is not limited in the present disclosure. For example, in some application scenarios, the at least one piece of request parameter information may include at least one of engine description information of the foregoing data engine and interface description information corresponding to the foregoing data processing request. The following separately describes the two types of information.

For the engine description information of the foregoing data engine, the engine description information is used for describing related content of the data engine that sends the foregoing data processing request, so that the engine description information can represent a feature presented by the data engine that sends the data processing request. In addition, the implementation of the engine description information is not limited in the present disclosure. For example, the engine description information may include at least one of an engine identifier of the data engine and a user identifier of the data engine. The engine identifier is used for uniquely identifying the data engine that sends the data processing request. In addition, the implementation of the engine identifier is not limited in the present disclosure. For example, the engine identifier may be implemented by using any information (for example, an IP address of the data engine) that can identify the data engine. The user identifier is used for uniquely identifying a user of the data engine that sends the data processing request. In addition, the user identifier is not limited in the present disclosure. For example, the user identifier may be implemented by using any information (for example, a user name or a login account of the data engine) that can identify a user.

For the interface description information corresponding to the foregoing data processing request, the interface description information is used for describing related content of an interface (for example, a Thrift interface) used when the data engine sends the data processing request, so that the interface description information can represent a feature presented by the interface. In addition, the implementation of the interface description information is not limited in the present disclosure. For example, the interface description information may include at least one of an interface identifier corresponding to the data processing request and an interface parameter corresponding to the data processing request. The interface identifier is used for uniquely identifying the interface used when the data engine sends the data processing request. In addition, the implementation of the interface identifier is not limited in the present disclosure. For example, the interface identifier may be implemented by using any information (for example, an interface name) that can identify an interface. The interface parameter is used for describing a parameter (for example, a delivering parameter of the interface) that needs to be provided to the interface when the data engine uses the interface to send the data processing request. In addition, the implementation of the interface parameter is not limited in the present disclosure.

In addition, the implementation of the step “generating the first request identification information based on the at least one piece of request parameter information of the data processing request” is not limited in the present disclosure. For example, the implementation may specifically be as follows: generating the first request identification information based on the at least one piece of request parameter information of the data processing request, so that the first request identification information includes at least one of the at least one piece of request parameter information and a request tracking identifier (for example, a traceID generated by a metadata service gateway shown in FIG. 4) generated by the metadata server for the data processing request, so that the first request identification information can represent the feature of the data processing request. The “request tracking identifier generated by the metadata server for the data processing request” refers to a tracking identifier (for example, a traceID) that is generated by the metadata server (for example, the metadata service gateway shown in FIG. 4) based on the at least one piece of request parameter information and that is used for uniquely identifying the data processing request. In addition, the implementation of a generation process of the “request tracking identifier generated by the metadata server for the data processing request” is not limited in the present disclosure. For example, the generation process may be similar to the implementation of an SDK generating a tracking identifier (for example, a traceID).

It can be learned from the foregoing four paragraphs of content that in some application scenarios, if a data engine neither supports a log identifier nor supports a request tracking identifier (for example, an SDK deployed in the data engine is an old SDK shown in FIG. 4), when the data engine sends a data processing request to a metadata server, the data engine does not actively provide any information (for example, a logID, a traceID, or the like) that can reflect the feature of the data processing request to the metadata server. Therefore, in order to overcome a defect caused by separation of a log in the data engine and a log in the metadata server as much as possible, the metadata server may automatically obtain some parameters (for example, an interface name of the data processing request, an interface delivering parameter of the data processing request, an IP address of the data engine that sends the data processing request, a user name of the data engine that sends the data processing request, or the like) of the data processing request, so that the metadata server can generate identification information corresponding to the data processing request based on the parameters (for example, information such as the parameters and a traceID), so that the identification information can more accurately represent the feature of the data processing request, so that each log generated by the metadata server for the data processing request subsequently carries the identification information, so that each log generated by the metadata server for the data processing request can be quickly and accurately queried based on a log query scope and all or some content in the identification information later, thereby facilitating improvement of a log query effect.

It can be learned from the foregoing related content of the first request identification information that, for the first request identification information obtained by the foregoing metadata server, in some application scenarios (for example, an SDK deployed in a data engine is a new SDK shown in FIG. 4), the first request identification information may be request identification information (for example, a logID, a traceID, or the like) carried in the foregoing data processing request. In some other application scenarios (for example, an SDK deployed in a data engine is an old SDK shown in FIG. 4), the first request identification information may be determined based on at least one piece of request parameter information (for example, an interface name of the data processing request, an interface delivering parameter of the data processing request, an IP address of the data engine that sends the data processing request, a user name of the data engine that sends the data processing request, or the like) of the data processing request.

In fact, for the foregoing metadata server, the metadata server may have different structures in different application scenarios, so that S102 may have different implementations. For ease of understanding, the following description is provided by using two examples.

Example 1: When the foregoing metadata server is a metadata service system (for example, the metadata service system shown in FIG. 2), S102 may specifically be: after receiving the data processing request sent by the foregoing data engine, the metadata service system may determine the first request identification information based on the data processing request, so that the first request identification information is used for identifying the data processing request, so that the first request identification information can represent a feature of the data processing request.

Example 2: When the foregoing metadata server includes a metadata service gateway (for example, the metadata service gateway shown in FIG. 3) and at least one metadata service system (for example, the metadata service system 1 to the metadata service system M shown in FIG. 3), S102 may specifically be: after receiving the data processing request sent by the data engine, the metadata service gateway may determine the first request identification information based on the data processing request, so that the first request identification information is used for identifying the data processing request, so that the first request identification information can represent a feature of the data processing request.

In addition, the implementation of the step “the metadata service gateway may determine the first request identification information based on the data processing request” is not limited in the present disclosure. For example, the implementation may specifically be as follows: if the data processing request carries request identification information, the metadata service gateway may determine the first request identification information based on the request identification information carried in the data processing request. However, if the data processing request does not carry request identification information (for example, the foregoing data engine is not configured to provide a log identifier, and the data engine is not configured to generate a request tracking identifier for the foregoing data processing request), the metadata service gateway may generate the first request identification information based on at least one piece of request parameter information of the data processing request.

It can be learned from the foregoing related content of S102 that for the foregoing metadata server, after receiving the data processing request sent by the data engine, the metadata service server may determine the first request identification information based on the data processing request, so that the first request identification information is used for identifying the data processing request, so that the first request identification information can represent a feature of the data processing request, so that the metadata server can subsequently perform log generation processing based on the first request identification information, so that a finally generated log carries the first request identification information.

S103: The metadata server executes request processing logic corresponding to the data processing request, and generates, based on the first request identification information, a log corresponding to the request processing logic, where the log carries the first request identification information.

The request processing logic corresponding to the data processing request refers to processing logic that needs to be executed when the metadata server processes the data processing request, so that the metadata server can implement a data processing requirement represented by the data processing request by executing the request processing logic. In addition, the implementation of the request processing logic is not limited in the present disclosure. For example, the request processing logic may refer to a sequence of steps preset for the data processing request.

In addition, for the request processing logic corresponding to the foregoing data processing request, the log corresponding to the request processing logic is used for describing related content of the request processing logic (for example, what is a request that triggers the request processing logic and what steps are specifically included in the request processing logic), so that the log can represent steps executed by the metadata server when processing the data processing request, so that the log can represent what processing is executed by the metadata server for the data processing request. In addition, the implementation of the log corresponding to the request processing logic is not limited in the present disclosure. For example, the log corresponding to the request processing logic may at least include an execution log of the request processing logic. The execution log refers to a log generated when the request processing logic is executed.

In addition, for the log corresponding to the foregoing request processing logic, the log carries the foregoing first request identification information, so that the log can be found based on the first request identification information later, thereby facilitating connection of a log in a data engine and a log in the metadata server.

In addition, the implementation of S103 is not limited in the present disclosure. For example, in some application scenarios, when the foregoing metadata server is a metadata service system (for example, the metadata service system shown in FIG. 2), S103 may specifically be: after receiving the data processing request sent by the foregoing data engine, the metadata service system executes request processing logic corresponding to the data processing request, and generates, based on the foregoing first request identification information, a log corresponding to the request processing logic, so that the log carries the first request identification information, so that the log can be queried based on the first request identification information subsequently, thereby facilitating connection of the log in the metadata service system and the log in the data engine.

For another example, in some application scenarios, when the foregoing metadata server includes a metadata service gateway (for example, the metadata service gateway shown in FIG. 3) and at least one metadata service system (for example, the metadata service system 1 to the metadata service system M shown in FIG. 3), S103 may specifically include the following steps 11 to 12.

Step 11: The metadata service gateway generates a data processing message carrying first request identification information based on the foregoing data processing request, the metadata service gateway sends the data processing message to a target system in the foregoing at least one metadata service system, and the metadata service gateway generates a metadata service gateway log corresponding to the data processing message based on the first request identification information, where the metadata service gateway log carries the first request identification information.

The data processing message refers to a message that needs to be used when a metadata service gateway delivers a data processing requirement described by the data processing request to a metadata service system, so that the data processing message carries the data processing requirement described by the data processing request.

In addition, the implementation of the foregoing data processing message is not limited in the present disclosure. For example, the data processing message may be implemented by using a Thrift protocol format.

In addition, the generation process of the foregoing data processing message is not limited in the present disclosure. For example, if the foregoing data processing request carries the first request identification information, the generation process of the data processing message may specifically be as follows: the metadata service gateway directly sends the data processing request to a corresponding metadata service system as the data processing message. For another example, if the data processing request does not carry the first request identification information, the generation process of the data processing message may specifically be as follows: the metadata service gateway writes the first request identification information into a third field in the data processing request. The third field refers to a field in the data processing request that can be used for recording the first request identification information. In addition, the implementation of the third field is not limited in the present disclosure. For example, the third field may be implemented by using a field in an idle state in the data processing request. It can be seen that when the data processing request is implemented by using a Thrift protocol format shown in FIG. 5, the third field may be implemented by using an idle field 0 (for example, Field0).

In addition, for the data processing message, the metadata service gateway log corresponding to the data processing message is used for recording an item related to the data processing message that occurs in the metadata service gateway. In addition, the metadata service gateway log carries the first request identification information, so that the metadata service gateway log can be found based on the first request identification information subsequently, thereby facilitating connection of the log in the metadata service gateway and the log in the data engine.

The target system refers to a metadata service system selected by the metadata service gateway from the foregoing at least one metadata service system and that is used for processing the foregoing data processing request. In addition, the determination manner of the target system is not limited in the present disclosure. For example, the determination manner may be implemented by using a metadata service system selection rule pre-configured for the metadata service gateway.

It can be learned from the foregoing related content of step 11 that, for the metadata service gateway in the metadata server, after receiving the data processing request sent by the data engine, the metadata service gateway may generate a data processing message carrying first request identification information based on the data processing request, the metadata service gateway may send the data processing message to a target system in the foregoing at least one metadata service system, and the metadata service gateway may generate a metadata service gateway log (for example, a log that describes a generation process, a sending process, or the like of the data processing message) corresponding to the data processing message based on the first request identification information, so that the metadata service gateway log carries the first request identification information, so that the metadata service gateway log can be queried based on the first request identification information subsequently, thereby facilitating connection of the log in the metadata service gateway and the log in the data engine.

Step 12: The foregoing target system executes message processing logic corresponding to the foregoing data processing message, and the target system generates, based on the first request identification information carried in the data processing message, a system log corresponding to the message processing logic, where the system log carries the first request identification information.

The message processing logic corresponding to the data processing message refers to processing logic that needs to be executed when the target system processes the data processing message, so that the target system can implement a data processing requirement represented by the data processing message by executing the message processing logic. In addition, the implementation of the message processing logic is not limited in the present disclosure. For example, the message processing logic may refer to a sequence of steps preset for the data processing message.

In addition, for the system log corresponding to the foregoing message processing logic, the system log is used for describing related content of the message processing logic (for example, what is a Thrift message that triggers the message processing logic and what steps are specifically included in the message processing logic), so that the system log can represent steps executed by the target system when processing the foregoing data processing message. In addition, the implementation of the system log is not limited in the present disclosure. For example, the system log may at least include an execution log of the message processing logic. The execution log refers to a log generated when the message processing logic is executed.

In addition, for the system log corresponding to the foregoing message processing logic, the system log carries the foregoing first request identification information, so that the log can be found based on the first request identification information later, thereby facilitating connection of a log in a data engine, a log in a metadata service gateway, and a log in a metadata service system.

It can be learned from the foregoing related content of step 11 to step 12 that in some application scenarios, if the foregoing metadata server includes a metadata service gateway and at least one metadata service system, after the metadata service gateway in the metadata server receives the data processing request sent by the foregoing data engine, the metadata service gateway may generate a data processing message carrying first request identification information based on the data processing request, the metadata service gateway may send the data processing message to a target system in the foregoing at least one metadata service system, and the metadata service gateway may generate a metadata service gateway log (for example, a log that describes a generation process, a sending process, or the like of the data processing message) corresponding to the data processing message based on the first request identification information; and then the target system executes message processing logic corresponding to the data processing message, and the target system generates, based on the first request identification information carried in the data processing message, a system log corresponding to the message processing logic, wherein the system log carries the first request identification information, so that the metadata service gateway log and the system log can be located based on the first request identification information subsequently, thereby facilitating connection of the log in the data engine, the log in the metadata service gateway, and the log in the metadata service system.

It can be learned from the foregoing related content of S101 to S103 that, for the method of generating lakehouse metadata service log provided in this embodiment of the present disclosure, after a metadata server (for example, a metadata server that is composed of a metadata service gateway and a plurality of metadata service systems) receives a data processing request sent by a data engine, the metadata server determines first request identification information based on the data processing request, so that the first request identification information is used for identifying the data processing request, so that the first request identification information can represent a feature (for example, a log identifier, a request tracking identifier, or the like) of the data processing request; and then the metadata server executes request processing logic corresponding to the data processing request, and generates, based on the first request identification information, a log corresponding to the request processing logic, so that the log carries the first request identification information, so that the first request identification information can be used as a medium to associate the log corresponding to the request processing logic with a log generated for the data processing request in the data engine, so that the log in the metadata server and the log in the data engine can be connected by means of the first request identification information, so that a complete log (namely, a log recorded by the metadata server for the data processing request and a log recorded by the data engine for the data processing request) related to any data processing request in the data engine can be queried by means of the first request identification information subsequently, so that a defect caused by separation of a log in the data engine and a log in a metadata service system can be effectively overcome, thereby facilitating improvement of a log query effect (for example, improving query accuracy and improving query efficiency).

In fact, in order to better avoid interference of currently recorded identification information (for example, a logID and a traceID shown in FIG. 4) on a next data processing process, the present disclosure further provides a possible implementation of the foregoing method of generating a lakehouse metadata service log. For ease of understanding, the following description is provided by using an example.

As an example, when the foregoing metadata server includes a metadata service gateway and at least one metadata service system, the foregoing method of generating a lakehouse metadata service log may include the following steps 21 to 27.

Step 21: The metadata service gateway receives a data processing request sent by a data engine.

It should be noted that the related content of step 21 is similar to the related content in S101.

Step 22: The metadata service gateway determines first request identification information based on the foregoing data processing request, wherein the first request identification information is used for identifying the data processing request.

It should be noted that the implementation of the determination process of the first request identification information in step 22 is similar to the implementation of the determination process of the first request identification information in S102.

Step 23: The metadata service gateway generates a data processing message carrying the foregoing first request identification information based on the foregoing data processing request, the metadata service gateway sends the data processing message to a target system in the foregoing at least one metadata service system, and the metadata service gateway generates a metadata service gateway log corresponding to the data processing message based on the first request identification information, wherein the metadata service gateway log carries the first request identification information.

It should be noted that for the related content of step 23, refer to the related content in step 11.

Step 24: The foregoing target system executes message processing logic corresponding to the foregoing data processing message, and the target system generates, based on the first request identification information carried in the data processing message, a system log corresponding to the message processing logic, wherein the system log carries the first request identification information.

It should be noted that for the related content of step 24, refer to the related content in step 12.

Step 25: After the target system executes the message processing logic corresponding to the foregoing data processing message, the target system performs clearing processing on first request identification information recorded in the target system, and the target system sends a first feedback message to the metadata service gateway.

The first feedback message refers to a message sent by the target system to the metadata service gateway and used for indicating that the message processing logic corresponding to the foregoing data processing message has been executed, so that the first feedback message can notify the metadata service gateway that the target system has processed the data processing message.

In addition, the implementation of the step “the target system performs clearing processing on first request identification information recorded in the target system” in the foregoing step 25 is not limited in the present disclosure. For example, the step may specifically be as follows: the target system performs clearing processing on the first request identification information recorded in an MDC of the target system, to prevent the first request identification information from interfering with a next data processing process of the target system.

It can be seen that for the foregoing target system, in a possible implementation, if the MDC of the target system records the first request identification information (for example, a logID and a traceID shown in FIG. 4), the target system may be configured to: after the message processing logic corresponding to the foregoing data processing message is determined, clear the first request identification information recorded in the MDC of the target system.

It can be learned from the foregoing related content of step 25 that, for the foregoing target system (for example, the metadata service system 1, the metadata service system 2, . . . , or the metadata service system M shown in FIG. 3), after detecting the message processing logic corresponding to the foregoing data processing message, the target system performs clearing processing on the first request identification information recorded in the target system (for example, clearing a log identifier, a request tracking identifier, or the like recorded in the MDC of the target system), and the target system sends a first feedback message to the metadata service gateway, so that the metadata service gateway can learn, from the first feedback message, that the target system has processed the data processing message.

Step 26: After receiving the foregoing first feedback message, the metadata service gateway performs clearing processing on first request identification information recorded in the metadata service gateway, and the metadata service gateway sends a second feedback message to a data engine.

The second feedback message refers to a message sent by the metadata service gateway to the data engine and used for indicating that request processing logic corresponding to the foregoing data processing request has been executed, so that the second feedback message can notify the data engine that the metadata service gateway has processed the data processing request.

In addition, the implementation of the step “the metadata service gateway performs clearing processing on first request identification information recorded in the metadata service gateway” in the foregoing step 26 is not limited in the present disclosure. For example, the step may specifically be as follows: the metadata service gateway performs clearing processing on the first request identification information recorded in an MDC of the metadata service gateway, to prevent the first request identification information from interfering with a next data processing process of the metadata service gateway.

It can be seen that for the foregoing metadata service gateway, in a possible implementation, if the MDC of the metadata service gateway records the first request identification information (for example, a logID and a traceID shown in FIG. 4), the metadata service gateway may be configured to: after receiving the first feedback message sent by the foregoing target system, clear the first request identification information recorded in the MDC of the metadata service gateway.

It can be learned from the foregoing related content of step 26 that, for the foregoing metadata service gateway (for example, the metadata service gateway shown in FIG. 3), after receiving the first feedback message sent by the foregoing target system, the metadata service gateway performs clearing processing on the first request identification information recorded in the metadata service gateway (for example, clearing a log identifier, a request tracking identifier, or the like recorded in the MDC of the metadata service gateway), and the metadata service gateway sends a second feedback message to the foregoing data engine, so that the data engine can learn, from the second feedback message, that the metadata service gateway has processed the foregoing data processing request.

Step 27: After the data engine receives the second feedback message, if the data engine records a target identifier corresponding to the foregoing first request identification information, the data engine performs clearing processing on the target identifier recorded in the data engine.

The target identifier corresponding to the first request identification information refers to an identifier that needs to be cleared in the first request identification information. In addition, the implementation of the target identifier is not limited in the present disclosure. For example, in some application scenarios (for example, a new SDK shown in FIG. 4 is deployed in the data engine, but the data engine does not support a logID), the target identifier may refer to all identifiers (for example, a logID and a traceID shown in FIG. 4) that are present in the first request identification information.

For another example, in some application scenarios (for example, a new SDK shown in FIG. 4 is deployed in the data engine, and the data engine supports a logID), if the data engine supports log identifier configuration (for example, the data engine supports an MDC or the like), and a log identifier and a request tracking identifier are present in the data engine, the target identifier may be the request tracking identifier.

It can be learned from the foregoing content in the foregoing paragraph that, in a possible implementation, if the foregoing data engine supports log identifier configuration (for example, the data engine supports an MDC or the like), and a log identifier and a request tracking identifier are recorded in the data engine, step 27 may specifically be as follows: after the data engine receives the second feedback message, the data engine performs clearing processing on the request tracking identifier recorded in the data engine (for example, clearing the request tracking identifier in the MDC of the data engine, but retaining the log identifier).

It can be learned from the foregoing related content of step 21 to step 27 that, in some application scenarios, for the foregoing data engine, the metadata service gateway, and the metadata service system, after the data processing request sent by the data engine is processed by means of mutual cooperation between the metadata service gateway and the metadata service system, it is necessary to clear identification information (for example, a logID and a traceID shown in FIG. 4) recorded in an MDC of the metadata service system, clear identification information recorded in an MDC of the metadata service gateway, and clear all or some of the identification information recorded in an MDC of the data engine, so that interference of the identification information on a next data processing process can be effectively avoided.

In order to better understand the method of generating a lakehouse metadata service log provided in the present disclosure, the following uses an application scenario shown in FIG. 3 to FIG. 4 as an example for description.

As an example, if data communication is performed between a data engine n (for example, an engine such as Spark) and a metadata service gateway by using a Thrift protocol, and data communication is performed between the metadata service gateway and a metadata service system m (for example, any HiveMetastore shown in FIG. 4) by using a Thrift protocol, n is a positive integer, n≤N, m is a positive integer, and m≤M, the solution of generating the lakehouse metadata service log provided in the present disclosure may include the following steps 31 to 40.

Step 31: The data engine n sends a data processing request (for example, a Thrift request) to the metadata service gateway by using an SDK deployed in the data engine n, to implement access, by the data engine n, to the metadata service gateway by using the SDK.

Step 32: For the SDK deployed in the foregoing data engine n, the SDK may obtain a logId from the data engine n, and place the logID in a field 0 (namely, a field 0 shown in FIG. 5) of a Thrift message.

It should be noted that the specific implementation of the foregoing step 32 is not limited in the present disclosure. For example, step 32 includes the following steps 321 to 322.

Step 321: If the foregoing data engine n does not support an MDC, the data engine n may set the logId by using an SDK method. For example, Spark may specify an applicationId as the logId.

Step 322: If the foregoing data engine n supports the MDC, the SDK deployed in the data engine n automatically reads the logId from the MDC.

Step 33: For the foregoing data engine n, each time the data engine n generates a Thrift request (for example, the foregoing data processing request or the like), the SDK deployed in the data engine n automatically generates a globally unique traceId, so that the traceId can uniquely identify the current Thrift request, and the SDK further places the traceID in the field 0 of the Thrift message. Subsequently, a log of the Thrift request automatically carries the logId and the traceId.

Step 34: For the SDK deployed in the foregoing data engine n, when initiating the Thrift request, the SDK records the logId and the traceId of the Thrift request in a log of the data engine n, so that a data engine such as Spark/Flink that does not support the MDC can perform tuning and troubleshooting.

Step 35: For the foregoing metadata service gateway, after receiving the Thrift request carrying the Thrift message that is sent by the foregoing data engine n, the metadata service gateway first marks a binary stream (for example, marks a start position and an end position of the Thrift message or the like), and then the metadata service gateway reads the logId and the traceId from the field 0 of the Thrift message, and stores the logId and the traceId in an MDC of the metadata service gateway, and resets the binary stream. Subsequently, a log related to the Thrift request in the metadata service gateway automatically carries the logId and the traceId.

Step 36: For the foregoing metadata service gateway, the metadata service gateway starts to process the foregoing Thrift request, and routes the Thrift request to a metadata service system m (for example, a specific Hive Metastore shown in FIG. 4) as required. The metadata service system m refers to a metadata service system which is determined by the metadata service gateway and which needs to process the Thrift request.

Step 37: For the foregoing metadata service system m, after receiving the Thrift request carrying the Thrift message, the metadata service system m first marks a binary stream, and then the metadata service system m reads the traceId and the logId from the field 0 of the Thrift message, and resets the binary stream. Subsequently, a log related to the Thrift request in the metadata service system m automatically carries the logId and the traceId.

Step 38: For the foregoing metadata service system m, the metadata service system m processes the foregoing Thrift request, so that after the metadata service system m processes the Thrift request, the metadata service system m sends a feedback message to the metadata service gateway, and the metadata service system m clears the logId and the traceId in the MDC of the metadata service system m.

Step 39: For the foregoing metadata service gateway, after receiving the feedback message sent by the foregoing metadata service system m, the metadata service gateway sends a feedback message to the foregoing data engine n, and the metadata service gateway clears the logId and the traceId in the MDC of the metadata service gateway.

Step 40: For the foregoing data engine n, after an SDK deployed in the data engine n receives the feedback message sent by the foregoing metadata service gateway, if the data engine n supports the MDC, the data engine n clears the traceId in the MDC of the data engine n, and the logId remains unchanged.

It can be learned from the foregoing related content of step 31 to step 40 that, in some application scenarios, a log in a data engine, a log in a metadata service gateway, and a log in a metadata service system can be connected by means of the logId and the traceId shown in FIG. 4, so that a data access log in a big data scenario can be correlated at a low cost, ensuring smooth implementation of the entire solution.

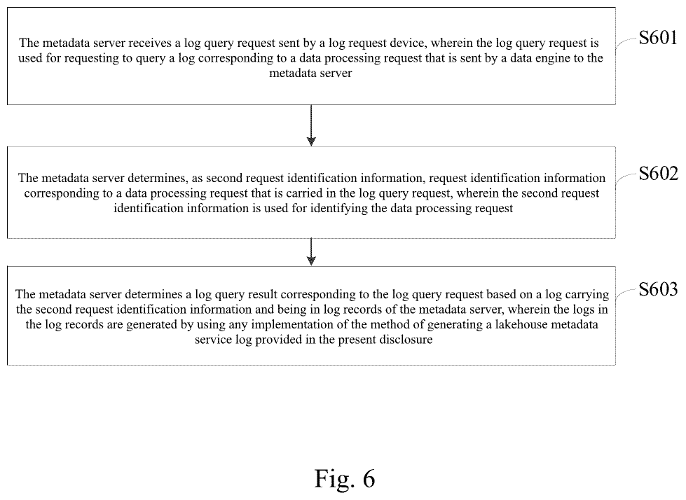

Based on the foregoing related content of the method of generating a lakehouse metadata service log, the present disclosure further provides a method of querying a lakehouse metadata service log. The following provides explanations and descriptions with reference to some accompanying drawings. As shown in FIG. 6, the method of querying a lakehouse metadata service log may include the following S601 to S604. FIG. 6 is a flowchart of a method of querying a lakehouse metadata service log according to an embodiment of the present disclosure.

S601: A metadata server receives a log query request sent by a log request device, wherein the log query request is used for requesting to query a log corresponding to a data processing request that is sent by a data engine to the metadata server.

The log request device refers to a device with a log query requirement. In addition, the implementation of the log request device is not limited in the present disclosure. For example, in some application scenarios, the log request device may refer to a data engine that can perform data communication with the foregoing metadata server. For another example, in some application scenarios, the log request device may refer to another device other than the metadata server and the data engine, and the other device can obtain some log content from the metadata server and the data engine.

The log query request refers to a request sent by the foregoing log request device to the metadata server and used for requesting the metadata server for some log content. For example, the log query request may be used for requesting to query a log corresponding to a data processing request that is sent by the foregoing data engine to the metadata server, so that the log can represent what processing is performed by the metadata server for the data processing request.

In addition, the implementation of the foregoing log query request is not limited in the present disclosure. For ease of understanding, the following description is provided by using three examples.

Example 1: In some application scenarios (for example, a scenario in which a new SDK is deployed in a data engine and the data engine supports a log identifier), when the log query request is used for requesting to query a log corresponding to a data processing request that is sent by a data engine to a metadata server, the log query request may carry a log identifier and a request tracking identifier corresponding to the data processing request, so that the metadata server can subsequently query, based on the two identifiers, a log related to the data processing request.

Example 2: In some application scenarios (for example, a scenario in which a new SDK is deployed in a data engine but the data engine does not support a log identifier), when the log query request is used for requesting to query a log corresponding to a data processing request that is sent by a data engine to a metadata server, the log query request may carry a request tracking identifier corresponding to the data processing request, so that the metadata server can subsequently query, based on the identifier, a log related to the data processing request.

It can be learned from the foregoing two paragraphs of content that, in a possible implementation, when the log query request is used for requesting to query a log corresponding to a data processing request that is sent by a data engine to a metadata server, the log query request may carry request identification information (for example, a logID and a traceID shown in FIG. 4) corresponding to the data processing request, so that the request identification information can represent a feature of the data processing request.

Example 3: In some application scenarios (for example, an old SDK is deployed in a data engine), when the log query request is used for requesting to query a log corresponding to a data processing request that is sent by a data engine to a metadata server, the log query request may carry a log query time range and at least one piece of request parameter information of the data processing request. The log query time range is used for representing a time range that needs to be used as a basis when a log related to the data processing request is queried from the metadata server. In addition, this embodiment of the present disclosure does not limit an obtaining manner of the log query time range. For example, the log query time range may be manually provided by a user, or may be automatically determined based on a sending time of the data processing request. It should be noted that for the related content of the at least one piece of request parameter information of the data processing request, refer to the foregoing description.

It can be learned from the foregoing related content of S601 that, for the foregoing metadata server, after receiving a data processing request sent by a specific data engine, the metadata server can not only process the data processing request, but also record some logs for the data processing request, so that the logs can represent what processing is performed by the metadata server for the data processing request, so that after subsequently receiving a log query request sent by a specific log request device for the data processing request, the metadata server can feed back the logs to the log request device, so that the log request device can learn, from the logs, what processing is performed by the metadata server for the data processing request.

S602: The metadata server determines, as second request identification information, request identification information corresponding to a data processing request that is carried in the log query request, wherein the second request identification information is used for identifying the data processing request.

The second request identification information refers to an identifier that needs to be used as a basis when a log of the metadata server is queried, so that the second request identification information can represent a feature of a data processing request described by the foregoing log query request.

In addition, the implementation of the determination process of the foregoing second request identification information is not limited in the present disclosure. For ease of understanding, the following description is provided by using four examples.

Example 1: When the foregoing log query request is used for requesting to query a log corresponding to a data processing request that is sent by a data engine to a metadata server, and the log query request carries a log identifier and a request tracking identifier corresponding to the data processing request, the determination process of the foregoing second request identification information may specifically be as follows: the metadata server extracts the log identifier and the request tracking identifier from the log query request, as the second request identification information.

Example 2: When the foregoing log query request is used for requesting to query a log corresponding to a data processing request that is sent by a data engine to a metadata server, and the log query request carries a request tracking identifier corresponding to the data processing request, the determination process of the foregoing second request identification information may specifically be as follows: the metadata server extracts the request tracking identifier from the log query request, as the second request identification information.

It can be learned from the foregoing two examples that, in a possible implementation, when the log query request is used for requesting to query a log corresponding to a data processing request that is sent by a data engine to a metadata server, the log query request carries request identification information (for example, a logID and a traceID shown in FIG. 4) corresponding to the data processing request, and the request identification information is used for identifying the data processing request, the determination process of the foregoing second request identification information may specifically be as follows: the metadata server determines, as the second request identification information, the request identification information carried in the log query request.

Example 3: When the foregoing log query request is used for requesting to query a log corresponding to a data processing request that is sent by a data engine to a metadata server, and the log query request does not carry request identification information corresponding to the data processing request but carries a log query time range and at least one piece of request parameter information of the data processing request, the determination process of the foregoing second request identification information may specifically be as follows: the metadata server generates the second request identification information based on the at least one piece of request parameter information carried in the log query request, so that the second request identification information is used for identifying the data processing request. It should be noted that the implementation of the second request identification information is not limited in the present disclosure. For example, the implementation of the second request identification information is similar to the implementation of the foregoing first request identification information. In addition, the implementation of the foregoing step “the metadata server generates the second request identification information based on the at least one piece of request parameter information carried in the log query request” is not limited in the present disclosure. For example, the implementation of the step is similar to the implementation of the foregoing step “the metadata server generates the first request identification information based on the at least one piece of request parameter information of the data processing request”.

Example 4: When the foregoing log query request is used for requesting to query a log corresponding to a data processing request that is sent by a data engine to a metadata server, and the log query request carries a log query time range and at least one piece of request parameter information of the data processing request, the determination process of the foregoing second request identification information may specifically be as follows: the metadata server determines the second request identification information from log records of the metadata server based on the log query time range and the at least one piece of request parameter information carried in the log query request, so that the second request identification information is used for identifying the data processing request, so that the second request identification information can be locked by the metadata server by means of recorded content in the logs. The log records of the metadata server are used for recording some items in the metadata server. In addition, logs in the log records of the metadata server are all generated by using any implementation of the method of generating a lakehouse metadata service log provided in the present disclosure, so that the logs in the log records of the metadata server all carry identification information of a corresponding data processing request.

It should be noted that the implementation of the step “the metadata server determines the second request identification information from log records of the metadata server based on the log query time range and the at least one piece of request parameter information carried in the log query request” in the foregoing paragraph is not limited in the present disclosure. For example, the step may specifically be as follows: first, a target log that meets the log query time range and that carries the at least one piece of request parameter information of the data processing request is found from the log records of the metadata server, so that the target log carries the at least one piece of request parameter information, and a time (for example, a log creation time or the like) involved in the target log is within the log query time range; and then the second request identification information is determined based on the identification information (for example, a traceID or the like) for identifying a specific data processing request that appears in the target logs, so that the second request identification information at least includes the content “identification information for identifying a specific data processing request”.

It can be learned from the foregoing related content of S602 that, for the foregoing metadata server, after receiving the log query request sent by the log request device, if the log query request is used for requesting to query a log corresponding to a data processing request that is sent by a data engine to the metadata server, the metadata server may determine the second request identification information based on the log query request, so that the second request identification information is used for identifying the data processing request, so that the second request identification information can represent a feature of the data processing request.

S603: The metadata server determines a log query result corresponding to the log query request based on a log carrying the second request identification information and being in log records of the metadata server, wherein the logs in the log records are generated by using any implementation of the method of generating a lakehouse metadata service log provided in the present disclosure.

The log query result corresponding to the log query request is used for representing a log determined for the log query request in the metadata server, so that the log query result can represent what processing is performed by the metadata server for the foregoing data processing request.

In addition, the related content of S603 is not limited in the present disclosure. For example, when the foregoing log query request is used for requesting to query a log corresponding to a data processing request that is sent by a data engine to a metadata server, the log query request carries request identification information (for example, a logID and a traceID shown in FIG. 4) corresponding to the data processing request, and the S603 may specifically be as follows: the metadata server first queries, from the log records of the metadata server, a log carrying the request identification information, so that the log carrying the request identification information can represent what processing is performed by the metadata server for the data processing request; and then the metadata server determines the log query result corresponding to the log query request based on the log carrying the request identification information, so that the log query result includes the log carrying the request identification information, so that the log query result can represent what processing is performed by the metadata server for the data processing request.

For another example, when the foregoing log query request is used for requesting to query a log corresponding to a data processing request that is sent by a data engine to a metadata server, the log query request carries a log query time range and at least one piece of request parameter information of the data processing request, and the foregoing second request identification information is determined based on some or all information in the log query request, the S603 may specifically be as follows: the metadata server determines the log query result corresponding to the log query request based on a log (for example, the foregoing target log or the like) that is in the log records of the metadata server, that meets the log query time range, and that carries the second request identification information, so that the log query result includes “the log that meets the log query time range and that carries the second request identification information”, so that a log related to a specific data processing request can be located in the metadata server quickly on the premise that the data engine does not support a log identifier and a request tracking identifier, thereby facilitating improvement of a log query effect.

It can be learned from the foregoing related content of S603 that, for the foregoing metadata server, the metadata server may use a log that carries the foregoing second request identification information and that is in the log records of the metadata server as the log query result corresponding to the foregoing log query request, so that the log query result can accurately represent what processing is performed by the metadata server for the data processing request involved in the log query request, so that the metadata server can subsequently feed back the log query result to the log request device, so that the log request device can learn, from the log query result, what processing is performed by the metadata server for the data processing request.

In addition, the working principle of the foregoing log request device is not limited in the present disclosure. For example, the working principle may at least include: integrating a log query result fed back by the foregoing metadata server and a log recorded for the foregoing data processing request in the foregoing data engine, to obtain an integrated log, so that the integrated log includes the log query result fed back by the metadata server and the log recorded for the data processing request in the data engine, so that the integrated log includes logs recorded for the data processing request by the metadata server and the data engine respectively, so that the integrated log is used for describing a process that is performed for the data processing request by using the data engine and the metadata server, so that the log request device can integrate all logs related to the data processing request, thereby facilitating improvement of a log query effect for the data processing request. The “log recorded for the data processing request in the data engine” refers to a log related to the data processing request and being in log records of the data engine. In addition, the obtaining method of the “log recorded for the data processing request in the data engine” is not limited in the present disclosure. For example, any log obtaining method may be used for implementation.

For another example, in order to better improve log obtaining efficiency, when the foregoing log query request is used for requesting to query a log corresponding to a data processing request that is sent by a data engine to a metadata server, and the log query request carries request identification information (for example, a logID and a traceID shown in FIG. 4) corresponding to the data processing request, the foregoing “log recorded for the data processing request in the data engine” may refer to a log carrying the request identification information and being in the log records of the data engine, so that a log recorded for the data request in each device can be quickly queried by using the identification information, thereby facilitating improvement of log query efficiency.

It can be learned from the foregoing related content of S601 to S604 that, for the foregoing metadata server, each log in the log records of the metadata server carries identification information of a data processing request corresponding to the log, so that a log related to the data processing request can be quickly found from the log records of the metadata server based on the identification information of the data processing request later, so that a log in the metadata server and a log in a data engine can be connected by means of the log information, thereby facilitating improvement of a log query effect (for example, log query efficiency and log integrity) for a specific data processing request.

It can be learned from the foregoing related content of the method of generating a lakehouse metadata service log and the method of querying a lakehouse metadata service log that, the technical solution provided in the present disclosure has the following advantages \textcircled{1} and \textcircled{2}.

\textcircled{1} For a data engine that can upgrade an SDK (namely, a data engine with a new SDK deployed), the advantage is as follows: if the data engine supports a logId through an MDC and an SDK deployed in the data engine can automatically generate a traceId, the data engine can transparently transmit the logId and the traceId to a metadata service gateway by using the SDK, and then the metadata service gateway transparently transmits the logId and the traceId to a corresponding metadata service system, so that a log in the data engine, a log in the metadata service gateway, and a log in the metadata service system all carry the logId and the traceId, so that logs recorded for a same data request in the three devices can be quickly queried by means of the logId and the traceId later, so that a data access log in a big data scenario can be correlated at a low cost, thereby facilitating improvement of a log query effect. However, if the data engine does not support the logId through the MDC, such as Spark and Flink, the SDK deployed in the data engine can still automatically generate the traceId and transparently transmit the traceId to the metadata service gateway, and then the metadata service gateway transparently transmits the traceId to the corresponding metadata service system, so that the log in the data engine, the log in the metadata service gateway, and the log in the metadata service system all carry the traceId, so that logs recorded for a data request in the three devices can be quickly queried by means of the traceId later, so that a data access log in a big data scenario can be correlated at a low cost, thereby facilitating improvement of a log query effect.

\textcircled{2} For a data engine that cannot upgrade an SDK (namely, a data engine with an old SDK deployed), the advantage is as follows: because the old SDK does not transparently transmit any logId or traceId to a metadata service gateway, in order to better connect a log in the data engine and a log in the metadata service gateway, the metadata service gateway obtains a parameter of each Thrift request (for example, information such as a name of a requested interface, a delivering parameter, a client IP address, and a user name), the metadata service gateway automatically generates the traceId based on the parameters, and the metadata service gateway transparently transmits the traceID to a metadata service system (for example, a Hive Metastore), so that the log in the metadata service gateway and the log in the metadata service system both carry the traceId, so that logs recorded for a data request in the two devices can be quickly queried by means of the traceId later, so that when tuning and troubleshooting are required subsequently, a metadata service gateway log can be searched for based on a time range and the request parameter, the traceId is locked, and then logs in the metadata service gateway and the metadata service system are correlated based on the traceId, thereby facilitating improvement of a log query effect.

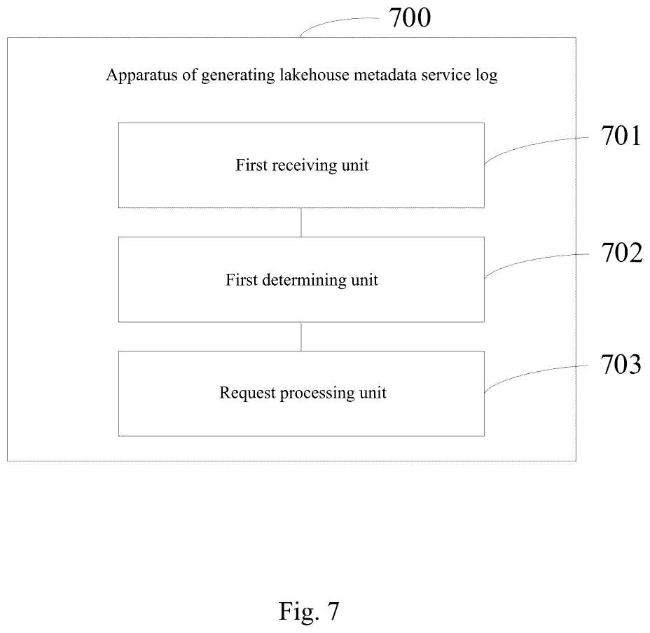

Based on the method of generating a lakehouse metadata service log provided in the embodiments of the present disclosure, the embodiments of the present disclosure further provide an apparatus of generating lakehouse metadata service log. The following provides explanations and descriptions with reference to FIG. 7. FIG. 7 is a schematic diagram of a structure of an apparatus of generating a lakehouse metadata service log according to an embodiment of the present disclosure. It should be noted that for technical details of the apparatus of generating a lakehouse metadata service log provided in the embodiments of the present disclosure, refer to the related content of the foregoing method of generating a lakehouse metadata service log.

As shown in FIG. 7, the apparatus 700 of generating a lakehouse metadata service log provided in the embodiments of the present disclosure includes:
a first receiving unit 701, configured to receive a data processing request sent by a data engine;
a first determining unit 702, configured to determine first request identification information based on request identification information carried in the data processing request, wherein the first request identification information is used for identifying the data processing request; if the data engine provides a log identifier and the data engine generates a request tracking identifier for the data processing request, the request identification information includes the log identifier and the request tracking identifier; and if the data engine does not provide the log identifier but the data engine generates the request tracking identifier for the data processing request, the request identification information includes the request tracking identifier; and
a request processing unit 703, configured to execute request processing logic corresponding to the data processing request, and generate a log corresponding to the request processing logic based on the first request identification information, wherein the log carries the first request identification information.

In a possible implementation, the log identifier is determined by a software development kit (SDK) in the data engine based on a target parameter of the data engine; and
if the data engine supports log identifier configuration, the target parameter is a log identifier that is pre-configured for the data engine;
if the data engine does not support log identifier configuration, the target parameter is a task identifier, wherein the task identifier is used for identifying a data analysis task that triggers request generation logic of the data processing request, and the data analysis task is created by the data engine in response to a user operation.

In a possible implementation, the request tracking identifier is used for uniquely identifying the data processing request; and/or the request tracking identifier is generated by the SDK in the data engine.

In a possible implementation, the request identification information is located in a preset field in the data processing request; and/or the request identification information is written into the preset field in the data processing request by the SDK in the data engine.

In a possible implementation, the first determining unit 702 is further configured to determine the first request identification information based on at least one piece of request parameter information of the data processing request if the data processing request does not carry the request identification information, wherein the at least one piece of request parameter information includes at least one of engine description information of the data engine and interface description information corresponding to the data processing request.

In a possible implementation, the first request identification information includes at least one of the at least one piece of request parameter information and a request tracking identifier that is generated by the metadata server for the data processing request.

In a possible implementation, the first determining unit 702 is specifically configured to determine the first request identification information based on at least one piece of request parameter information of the data processing request if the data engine does not provide the log identifier and the data engine does not generate the request tracking identifier for the data processing request.

In a possible implementation, the engine description information includes at least one of an engine identifier of the data engine and a user identifier of the data engine.

In a possible implementation, the interface description information includes at least one of an interface identifier corresponding to the data processing request and an interface parameter corresponding to the data processing request.

In a possible implementation, the apparatus 700 of generating a lakehouse metadata service log is a metadata service system.

In a possible implementation, the apparatus 700 of generating a lakehouse metadata service log includes a metadata service gateway and at least one metadata service system;
the first determining unit 702 is specifically configured to determine the first request identification information based on the data processing request by the metadata service gateway; and
the request processing unit 703 is specifically configured to generate, by the metadata service gateway, a data processing message carrying the first request identification information based on the data processing request, send, by the metadata service gateway, the data processing message to a target system in the at least one metadata service system, and generate a metadata service gateway log corresponding to the data processing message by the metadata service gateway based on the first request identification information, wherein the metadata service gateway log carries the first request identification information; execute, by the target system, message processing logic corresponding to the data processing message, and generate a system log corresponding to the message processing logic by the target system based on the first request identification information carried in the data processing message, wherein the system log carries the first request identification information.

In a possible implementation, the apparatus 700 of generating a lakehouse metadata service log further includes:
an identifier clearing unit, configured to: after the message processing logic corresponding to the data processing message is executed, perform clearing processing, by the target system, on the first request identification information recorded in the target system, and send a first feedback message to the metadata service gateway by the target system; and after the metadata service gateway receives the first feedback message, perform clearing processing, by the metadata service gateway, on the first request identification information recorded in the metadata service gateway, and send a second feedback message to the data engine by the metadata service gateway, so that after the data engine receives the second feedback message, if the data engine records a target identifier corresponding to the first request identification information, perform clearing processing, by the data engine, on the target identifier recorded in the data engine.

In a possible implementation, if the data engine supports log identifier configuration and the first request identification information recorded in the data engine includes a log identifier and a request tracking identifier, the target identifier is the request tracking identifier.

In a possible implementation, if the data processing request carries the first request identification information, the data engine is configured to generate an engine log for the data processing request, wherein the engine log carries the first request identification information.

It can be learned from the foregoing related content of the apparatus 700 of generating a lakehouse metadata service log that, for the apparatus 700 of generating a lakehouse metadata service log provided in the embodiments of the present disclosure, the apparatus 700 of generating a lakehouse metadata service log is integrated into the foregoing metadata server, and the working principle of the apparatus 700 of generating a lakehouse metadata service log is as follows: after receiving a data processing request sent by a data engine, the apparatus 700 of generating a lakehouse metadata service log determines first request identification information based on the data processing request, so that the first request identification information is used for identifying the data processing request, so that the first request identification information can represent a feature (for example, a log identifier and a request tracking identifier) of the data processing request; and then the apparatus 700 of generating a lakehouse metadata service log executes request processing logic corresponding to the data processing request, and generates a log corresponding to the request processing logic based on the first request identification information, so that the log carries the first request identification information, so that the first request identification information can be used as a medium to associate the log corresponding to the request processing logic with the log generated for the data processing request in the data engine, so that the log in the apparatus 700 of generating a lakehouse metadata service log and the log in the data engine can be connected by means of the first request identification information, so that a complete log (namely, a log recorded for the data processing request by the apparatus 700 of generating a lakehouse metadata service log and a log recorded for the data processing request by the data engine) related to any data processing request in the data engine can be queried by means of the first request identification information subsequently, so that a defect caused by separation of the log in the data engine and the log in a metadata service system can be effectively overcome, thereby facilitating improvement of a log query effect (for example, improving query accuracy and improving query efficiency).

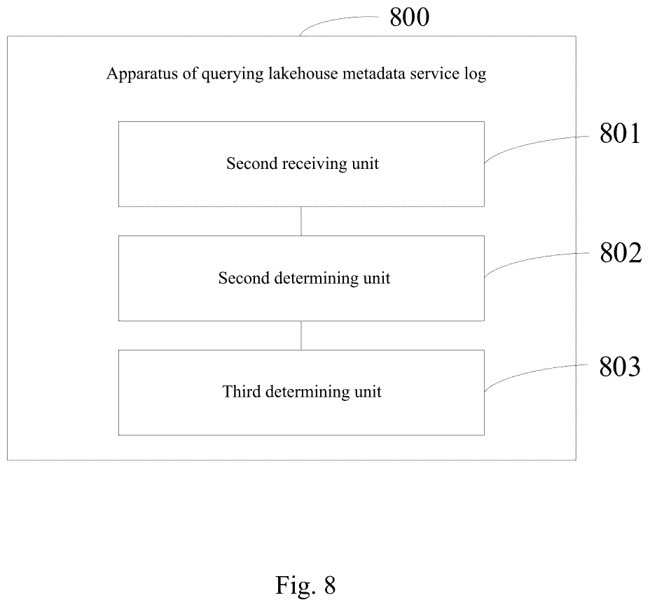

Based on the method of querying a lakehouse metadata service log provided in the embodiments of the present disclosure, the embodiments of the present disclosure further provide an apparatus of querying a lakehouse metadata service log. The following provides explanations and descriptions with reference to FIG. 8. FIG. 8 is a schematic diagram of a structure of an apparatus of querying a lakehouse metadata service log according to an embodiment of the present disclosure. It should be noted that for technical details of the apparatus of querying a lakehouse metadata service log provided in the embodiments of the present disclosure, refer to the related content of the foregoing method of querying a lakehouse metadata service log.

As shown in FIG. 8, an apparatus 800 of querying a lakehouse metadata service log provided in the embodiments of the present disclosure includes:
a second receiving unit 801, configured to receive a log query request sent by a log request device, wherein the log query request is used for requesting to query a log corresponding to a data processing request that is sent by a data engine to a metadata server;
a second determining unit 802, configured to determine, as second request identification information, request identification information corresponding to the data processing request that is carried in the log query request, wherein the second request identification information is used for identifying the data processing request; and
a third determining unit 803, configured to determine a log query result corresponding to the log query request based on a log carrying the second request identification information and being in log records of the metadata server, wherein the logs in the log records are generated by using any implementation of the method of generating a lakehouse metadata service log provided in the present disclosure.

In a possible implementation, the second determining unit 802 is further configured to: if the log query request does not carry the request identification information corresponding to the data processing request but carries a log query time range and at least one piece of request parameter information of the data processing request, generate the second request identification information based on the at least one piece of request parameter information carried in the log query request; or determine the second request identification information from the log records of the metadata server based on the log query time range and the at least one piece of request parameter information carried in the log query request, wherein the at least one piece of request parameter information includes at least one of engine description information of the data engine and interface description information corresponding to the data processing request; and
the third determining unit 803 is further configured to determine the log query result corresponding to the log query request based on a log that is in the log records of the metadata server, that meets the log query time range, and that carries the second request identification information.

In a possible implementation, the log request device is configured to integrate the log query result fed back by the metadata server and a log recorded for the data processing request in the data engine, to obtain an integrated log, wherein the integrated log is used for describing a process that is performed for the data processing request by using the data engine and the metadata server.

In a possible implementation, if the log query request carries the request identification information corresponding to the data processing request, the log recorded for the data processing request in the data engine refers to a log carrying the request identification information and being in log records of the data engine.

In a possible implementation, the log request device is the data engine.

It can be learned from the foregoing related content of the apparatus 800 of querying a lakehouse metadata service log that, for the apparatus 800 of querying a lakehouse metadata service log provided in the embodiments of the present disclosure, the apparatus 800 of querying a lakehouse metadata service log is integrated into the metadata server, and the working principle of the apparatus 800 of querying a lakehouse metadata service log is as follows: each log in the log records of the apparatus 800 of querying a lakehouse metadata service log carries identification information of a data processing request corresponding to the log, so that a log related to the data processing request can be quickly found from the log records of the apparatus 800 of querying a lakehouse metadata service log based on the identification information of the data processing request later, so that a log in the apparatus 800 of querying a lakehouse metadata service log and a log in a data engine can be connected by means of the log information, thereby facilitating improvement of a log query effect (for example, log query efficiency and log integrity) for a specific data processing request.

In addition, the embodiments of the present disclosure further provide an electronic device. The device includes a processor and a memory. The memory is configured to store an instruction or a computer program. The processor is configured to execute the instruction or the computer program in the memory, so that the electronic device executes any implementation of the method of generating a lakehouse metadata service log or the method of querying a lakehouse metadata service log provided in the embodiments of the present disclosure.

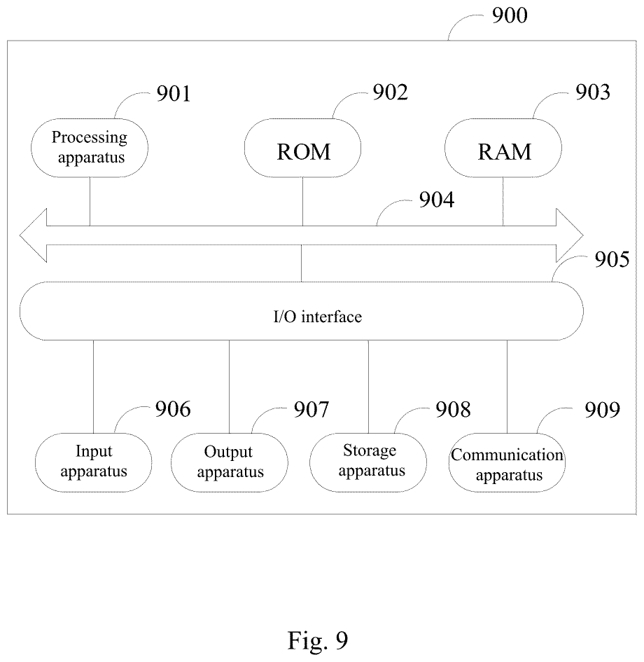

FIG. 9 is a schematic diagram of a structure of an electronic device 900 suitable for implementing an embodiment of the present disclosure. A terminal device in this embodiment of the present disclosure may include, but is not limited to, a mobile terminal such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and a fixed terminal such as a digital TV and a desktop computer. The electronic device shown in FIG. 9 is merely an example, and shall not impose any limitation on the function and scope of use of the embodiments of the present disclosure.

As shown in FIG. 9, the electronic device 900 may include a processing apparatus (for example, a central processor, a graphics processor, etc.) 901 that may perform a variety of appropriate actions and processing in accordance with a program stored in a read-only memory (ROM) 902 or a program loaded from a storage apparatus 908 into a random access memory (RAM) 903. The RAM 903 further stores various programs and data required for the operation of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touch screen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a tape and a hard disk; and a communication apparatus 909. The communication apparatus 909 may allow the electronic device 900 to perform wireless or wired communication with other devices to exchange data. Although FIG. 9 shows the electronic device 900 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 909 and installed, installed from the storage apparatus 908, or installed from the ROM 902. When the computer program is executed by the processing apparatus 901, the above-mentioned functions defined in the method of the embodiment of the present disclosure are performed.

The electronic device provided in this embodiment of the present disclosure and the method provided in the foregoing embodiment belong to the same inventive concept. For a technical detail that is not described in detail in this embodiment, reference may be made to the foregoing embodiment, and this embodiment and the foregoing embodiment have the same beneficial effects.

An embodiment of the present disclosure further provides a computer-readable medium storing an instruction or a computer program. When the instruction or the computer program runs on a device, the device is enabled to execute any implementation of the method of generating a lakehouse metadata service log or the method of querying a lakehouse metadata service log provided in the embodiments of the present disclosure.

It should be noted that the foregoing computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. Program code contained in the computer-readable medium may be transmitted by any suitable medium, including but not limited to: electric wires, optical cables, radio frequency (RF), and the like, or any suitable combination thereof.

In some implementations, the client and the server may communicate by using any currently known or future-developed network protocol such as a hypertext transfer protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The foregoing computer-readable medium may be contained in the foregoing electronic device. Alternatively, the computer-readable medium may exist independently, without being assembled into the electronic device.

The foregoing computer-readable medium carries one or more programs that, when executed by the electronic device, cause the electronic device to perform the foregoing method.

Computer program code for performing operations of the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving a remote computer, the remote computer may be connected to a computer of a user through any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the descriptions of the embodiments of the present disclosure may be implemented by means of software, or may be implemented by means of hardware. The name of a unit/a module does not constitute a limitation on the unit in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, the machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

It should be noted that the various embodiments in the present specification are described in a progressive manner, and each embodiment focuses on differences from other embodiments. For the same or similar parts between the embodiments, refer to each other. For the system or apparatus disclosed in the embodiments, since it corresponds to the method disclosed in the embodiments, the description is relatively simple, and for related parts, refer to the description of the method part.

It should be understood that in the present disclosure, “at least one (item)” means one or more, and “a plurality of” means two or more. “And/or” describes an association relationship between associated objects, and represents that three relationships may exist. For example, “A and/or B” may represent the following cases: only A exists, only B exists, and both A and B exist, where A and B may be singular or plural. The character “/” generally indicates an “or” relationship between the associated objects. “At least one of the following items (pieces)” or a similar expression thereof refers to any combination of these items, including a single item (piece) or any combination of a plurality of items (pieces). For example, at least one of a, b, or c may represent: a, b, c, “a and b”, “a and c”, “b and c”, or “a, b, and c”, where a, b, and c may be singular or plural.

It should also be noted that in this article, relational terms such as first and second are only used to distinguish one entity or operation from another entity or operation, and do not necessarily require or imply any such actual relationship or order between these entities or operations. Moreover, the term “include”, “comprise” or any other variant thereof is intended to cover non-exclusive inclusion, so that a process, method, article, or device that includes a series of elements includes not only those elements, but also other elements not explicitly listed, or further includes elements inherent to such a process, method, article, or device. Without more restrictions, an element defined by the statement “include a/an . . . ” does not exclude the existence of additional identical elements in the process, method, article, or device including the element.

The steps of the method or algorithm described in connection with the embodiments disclosed herein may be directly implemented by hardware, a software module executed by a processor, or a combination thereof. The software module may be placed in a random memory (RAM), a memory, a read-only memory (ROM), an electrically programmable ROM, an electrically erasable programmable ROM, a register, a hard disk, a removable hard disk, a CD-ROM, or any other form of storage medium known in the art.

The foregoing descriptions of the disclosed embodiments enable those skilled in the art to implement or use the present disclosure. Various modifications to these embodiments will be readily apparent to those skilled in the art, and the general principles defined herein may be implemented in other embodiments without departing from the spirit or scope of the present disclosure. Therefore, the present disclosure is not limited to the embodiments shown herein, but is to conform to the widest scope consistent with the principles and novel features disclosed herein.

1. A method of generating a lakehouse metadata service log, wherein the method is applied to a metadata server, and the method comprises:
receiving a data processing request sent by a data engine;
determining first request identification information based on request identification information carried in the data processing request, wherein the first request identification information is used for identifying the data processing request; and if the data engine provides a log identifier and generates a request tracking identifier for the data processing request, the request identification information comprises the log identifier and the request tracking identifier; if the data engine does not provide a log identifier and generates a request tracking identifier for the data processing request, the request identification information comprises the request tracking identifier; and
executing request processing logic corresponding to the data processing request, and generating a log corresponding to the request processing logic based on the first request identification information, wherein the log carries the first request identification information.

2. The method according to claim 1, wherein the log identifier is determined by a software development kit (SDK) in the data engine based on a target parameter of the data engine; and
if the data engine supports log identifier configuration, the target parameter is a log identifier pre-configured for the data engine;
if the data engine does not support log identifier configuration, the target parameter is a task identifier, the task identifier is used for identifying a data analysis task of request generation logic that triggers the data processing request, and the data analysis task is created by the data engine in response to a user operation.

3. The method according to claim 1, wherein the request tracking identifier is used for uniquely identifying the data processing request; and/or
the request tracking identifier is generated by an SDK in the data engine.

4. The method according to claim 1, wherein the request identification information is located in a preset field in the data processing request; and/or
the request identification information is written by an SDK in the data engine into the preset field in the data processing request.

5. The method according to claim 1, further comprising:
determining the first request identification information based on at least one piece of request parameter information of the data processing request, if the data processing request does not carry the request identification information, wherein the at least one piece of request parameter information comprises at least one of engine description information of the data engine and interface description information corresponding to the data processing request.

6. The method according to claim 5, wherein the first request identification information comprises at least one of the at least one piece of request parameter information and a request tracking identifier generated by the metadata server for the data processing request; and/or
the determining the first request identification information based on at least one piece of request parameter information of the data processing request, if the data processing request does not carry the request identification information, comprises:
if the data engine does not provide a log identifier and does not generate a request tracking identifier for the data processing request, determining the first request identification information based on at least one piece of request parameter information of the data processing request.

7. The method according to claim 5, wherein the engine description information comprises at least one of an engine identifier of the data engine and a user identifier of the data engine; and/or
the interface description information comprises at least one of an interface identifier corresponding to the data processing request and an interface parameter corresponding to the data processing request.

8. The method according to claim 1, wherein the metadata server is a metadata service system.

9. The method according to claim 1, wherein the metadata server comprises a metadata service gateway and at least one metadata service system; and
the determining first request identification information based on request identification information carried in the data processing request comprises:
determining, by the metadata service gateway, the first request identification information based on the request identification information carried in the data processing request; and
the executing request processing logic corresponding to the data processing request, and generating a log corresponding to the request processing logic based on the first request identification information comprises:
generating, by the metadata service gateway, a data processing message carrying the first request identification information based on the data processing request, sending, by the metadata service gateway, the data processing message to a target system in the at least one metadata service system, and generating, by the metadata service gateway, a metadata service gateway log corresponding to the data processing message based on the first request identification information, wherein the metadata service gateway log carries the first request identification information; and
executing, by the target system, message processing logic corresponding to the data processing message, and generating, by the target system, a system log corresponding to the message processing logic based on the first request identification information carried in the data processing message, wherein the system log carries the first request identification information.

10. The method according to claim 9, further comprising:
after the message processing logic corresponding to the data processing message is executed, clearing, by the target system, the first request identification information recorded in the target system, and sending, by the target system, a first feedback message to the metadata service gateway;
after the metadata service gateway receives the first feedback message, clearing, by the metadata service gateway, the first request identification information recorded in the metadata service gateway, and sending, by the metadata service gateway, a second feedback message to the data engine; and
after the data engine receives the second feedback message, if a target identifier corresponding to the first request identification information is recorded in the data engine, clearing, by the data engine, the target identifier recorded in the data engine.

11. The method according to claim 10, wherein if the data engine supports log identifier configuration and the first request identification information recorded in the data engine comprises a log identifier and a request tracking identifier, the target identifier is the request tracking identifier.

12. The method according to claim 1, wherein if the data processing request carries the first request identification information, the data engine is configured to generate an engine log for the data processing request, and the engine log carries the first request identification information.

13. A method of querying a lakehouse metadata service log, wherein the method is applied to a metadata server, and the method comprises:
receiving a log query request sent by a log request device, wherein the log query request is used for requesting to query a log corresponding to a data processing request that is sent by a data engine to the metadata server;
determining, as second request identification information, request identification information corresponding to the data processing request and carried in the log query request, wherein the second request identification information is used for identifying the data processing request; and
determining a log query result corresponding to the log query request based on a log carrying the second request identification information and existing in a log record of the metadata server, wherein the log in the log record is generated by using the method of generating a lakehouse metadata service log according to claim 1.

14. The method according to claim 13, further comprising:
if the log query request does not carry the request identification information corresponding to the data processing request and the log query request carries a log query time range and at least one piece of request parameter information of the data processing request, generating the second request identification information based on the at least one piece of request parameter information carried in the log query request; or determining the second request identification information from the log record of the metadata server based on the log query time range and the at least one piece of request parameter information carried in the log query request, wherein the at least one piece of request parameter information comprises at least one of engine description information of the data engine and interface description information corresponding to the data processing request; and
determining the log query result corresponding to the log query request based on a log that exists in the log record of the metadata server, that meets the log query time range, and that carries the second request identification information.

15. The method according to claim 13, wherein the log request device is configured to integrate the log query result fed back by the metadata server and a log recorded in the data engine for the data processing request, to obtain an integrated log, and the integrated log is used for describing a process executed by using the data engine and the metadata server for the data processing request.

16. The method according to claim 15, wherein if the log query request carries the request identification information corresponding to the data processing request, the log recorded in the data engine for the data processing request is a log carrying the request identification information and existing in a log record of the data engine.

17. The method according to claim 13, wherein the log request device is the data engine.

18. An electronic device, wherein the device comprises a processor and a memory;
the memory is configured to store an instruction or a computer program; and
the processor is configured to execute the instruction or the computer program in the memory, so that the electronic device executes a method of generating a lakehouse metadata service log, wherein the method is applied to a metadata server, and the method comprises:
receiving a data processing request sent by a data engine;
determining first request identification information based on request identification information carried in the data processing request, wherein the first request identification information is used for identifying the data processing request; and if the data engine provides a log identifier and generates a request tracking identifier for the data processing request, the request identification information comprises the log identifier and the request tracking identifier; if the data engine does not provide a log identifier and generates a request tracking identifier for the data processing request, the request identification information comprises the request tracking identifier; and
executing request processing logic corresponding to the data processing request, and generating a log corresponding to the request processing logic based on the first request identification information, wherein the log carries the first request identification information.

19. An electronic device, wherein the device comprises a processor and a memory;
the memory is configured to store an instruction or a computer program; and
the processor is configured to execute the instruction or the computer program in the memory, so that the electronic device executes a method of querying a lakehouse metadata service log, wherein the method is applied to a metadata server, and the method comprises:
receiving a log query request sent by a log request device, wherein the log query request is used for requesting to query a log corresponding to a data processing request that is sent by a data engine to the metadata server;
determining, as second request identification information, request identification information corresponding to the data processing request and carried in the log query request, wherein the second request identification information is used for identifying the data processing request; and
determining a log query result corresponding to the log query request based on a log carrying the second request identification information and existing in a log record of the metadata server, wherein the log in the log record is generated by using the method of generating a lakehouse metadata service log according to claim 1.

20. A non-transitory computer-readable storage medium, wherein the non-transitory computer-readable storage medium stores an instruction or a computer program that, when running on a device, causes the device to execute
method of generating a lakehouse metadata service log, wherein the method is applied to a metadata server, and the method comprises:
receiving a data processing request sent by a data engine;
determining first request identification information based on request identification information carried in the data processing request, wherein the first request identification information is used for identifying the data processing request; and if the data engine provides a log identifier and generates a request tracking identifier for the data processing request, the request identification information comprises the log identifier and the request tracking identifier; if the data engine does not provide a log identifier and generates a request tracking identifier for the data processing request, the request identification information comprises the request tracking identifier; and
executing request processing logic corresponding to the data processing request, and generating a log corresponding to the request processing logic based on the first request identification information, wherein the log carries the first request identification information.
